(19) United States
(12) Patent Application Publication
(10) Pub. No.: US 2023/0387805 A1
(43) Pub. Date: Nov. 30, 2023

(54) SWITCHING POWER SUPPLY CIRCUIT AND SWITCHING POWER SUPPLY DEVICE

(71) Applicant: Rohm Co., Ltd., Kyoto (JP)

(72) Inventor: Tadashi AKAHO, Kyoto (JP)

(21) Appl. No.: 18/302,982

(22) Filed: Apr. 19, 2023

(30) Foreign Application Priority Data
May 27, 2022 (JP) 2022-086741

(51) Int. Cl. H02M 3/158; H02M 1/08; H02M 1/00

(52) U.S. Cl. CPC H02M 3/1588; H02M 1/0009; H02M 1/0025; H02M 1/08

(57) ABSTRACT

A switching power supply circuit includes an output stage circuit having an output transistor and a synchronous rectification transistor, and generates an output voltage. The switching power supply circuit includes an error amplifier to generate an error voltage corresponding to a difference between a feedback voltage corresponding to the output voltage and a predetermined reference voltage, a slope voltage generation circuit to generate a slope voltage, a comparator to generate a comparison result signal by comparing a first comparison voltage with a second comparison voltage which is the slope voltage or a sum of the slope voltage and a voltage corresponding to the inductor current, a clock signal generation circuit to generate a clock signal, a control drive circuit to control the output stage circuit based on the clock signal and the comparison result signal, and a reverse current detection circuit to detect a reverse current of the inductor current.

### CROSS-REFERENCE TO RELATED APPLICATION

This application is based upon and claims the benefit of priority from Japanese Patent Application No. 2022-086741, filed on May 27, 2022, the entire contents of which are incorporated herein by reference.

### TECHNICAL FIELD

The present disclosure relates to a switching power supply circuit and a switching power supply device.

### BACKGROUND

There has been known a switching power supply device that switches an input voltage by alternately turning on/off a pair of transistors connected in series with each other and generates an output voltage by rectifying/smoothing a resulting rectangular wave-shaped voltage.

In a switching power supply device of this type or in a circuit for constituting the switching power supply device, it is desired to improve efficiency as much as possible, particularly, for example, it is desired to improve efficiency at the time of a light load. Various techniques have been proposed as techniques for improving the efficiency, but there is room for improvement in these techniques.

### SUMMARY

Some embodiments of the present disclosure provide a switching power supply circuit and a switching power supply device that contribute to efficiency improvement (particularly, for example, efficiency improvement at the time of a light load).

According to one embodiment of the present disclosure, a switching power supply circuit includes an output stage circuit having an output transistor configured to receive an input voltage and a synchronous rectification transistor connected in series with the output transistor at a low potential side of the output transistor, and is configured to generate an output voltage from the input voltage by supplying an inductor current to an output inductor via the output transistor or the synchronous rectification transistor through turn-on/off of the output transistor and the synchronous rectification transistor. The switching power supply circuit includes: an error amplifier configured to generate an error voltage corresponding to a difference between a feedback voltage corresponding to the output voltage and a predetermined reference voltage; a slope voltage generation circuit configured to generate a slope voltage; a comparator configured to generate a comparison result signal by comparing a first comparison voltage, which is the error voltage, with a second comparison voltage which is the slope voltage or a sum of the slope voltage and a voltage corresponding to the inductor current; a clock signal generation circuit configured to generate a clock signal having a predetermined frequency; a control drive circuit configured to control the output stage circuit based on the clock signal and the comparison result signal; and a reverse current detection circuit configured to detect a reverse current of the inductor current, wherein the control drive circuit turns off the synchronous rectification transistor when the reverse current of the inductor current is detected while the synchronous rectification transistor is turned on, wherein the slope voltage generation circuit includes: a first offset voltage generation circuit configured to generate a first offset voltage corresponding to a ratio between a turn-on period of the output transistor and a turn-off period of the output transistor; and a second offset voltage generation circuit configured to generate a second offset voltage according to the output voltage, wherein the slope voltage is increased from the first offset voltage with a slope corresponding to the input voltage during the turn-on period of the output transistor, and wherein the slope voltage is set to the second offset voltage during at least a part of the turn-off period of the output transistor.

### BRIEF DESCRIPTION OF DRAWINGS

The accompanying drawings, which are incorporated in and constitute a part of the specification, illustrate embodiments of the present disclosure.

FIG. 1 is an overall configuration diagram of a switching power supply device according to an embodiment of the present disclosure.

FIG. 2 is an external perspective view of a power supply IC according to an embodiment of the present disclosure.

FIG. 3 is a waveform diagram of a clock signal according to an embodiment of the present disclosure.

FIG. 4 is a waveform diagram of a clock signal, a comparison result signal, and a control signal according to an embodiment of the present disclosure.

FIG. 5 is a timing chart of a first PWM control according to an embodiment of the present disclosure.

FIG. 6 is a modified timing chart of a first PWM control according to an embodiment of the present disclosure.

FIG. 7 is a timing chart of a second PWM control according to an embodiment of the present disclosure.

FIG. 8 is a modified timing chart of a second PWM control according to an embodiment of the present disclosure.

FIG. 9 is a modified timing chart of a second PWM control according to an embodiment of the present disclosure.

FIG. 10 is a modified timing chart of a skip control according to an embodiment of the present disclosure.

FIG. 11 is a timing chart of a first virtual operation according to an embodiment of the present disclosure.

FIG. 12 is a timing chart of a second virtual operation according to an embodiment of the present disclosure.

FIG. 13 is a configuration diagram of a slope voltage generation circuit according to a first Example belonging to an embodiment of the present disclosure.

FIG. 14 is a diagram for explaining an operation of a slope voltage generation circuit according to a first Example belonging to an embodiment of the present disclosure.

FIG. 15 is a diagram for explaining an operation of a slope voltage generation circuit according to a first Example belonging to an embodiment of the present disclosure (first control pattern).

FIG. 16 is a diagram for explaining an operation of a slope voltage generation circuit according to a first Example belonging to an embodiment of the present disclosure (second control pattern).

FIG. 17 is a diagram for explaining an operation of a slope voltage generation circuit according to a first Example belonging to an embodiment of the present disclosure (second control pattern).

FIG. 18 is a diagram for explaining an operation of a slope voltage generation circuit according to a first Example belonging to an embodiment of the present disclosure (third control pattern).

FIG. 19 is a diagram for explaining an operation of a slope voltage generation circuit according to a first Example belonging to an embodiment of the present disclosure (third control pattern).

FIG. 20 is a diagram for explaining how a first offset voltage and a slope voltage change, according to a first Example belonging to an embodiment of the present disclosure.

FIG. 21 is a diagram for explaining how a first offset voltage and a slope voltage change, according to a first Example belonging to the embodiment of the present disclosure.

FIG. 22 is a timing chart of a switching power supply device when a skip control is performed, according to a first Example belonging to an embodiment of the present disclosure.

FIG. 23 is a diagram for explaining a relationship between a pulse width of a control signal and an output current, according to a first Example belonging to an embodiment of the present disclosure.

FIG. 24 is a configuration diagram of a slope voltage generation circuit according to a second Example belonging to an embodiment of the present disclosure.

FIG. 25 is a configuration diagram of a slope voltage generation circuit according to a third Example belonging to an embodiment of the present disclosure.

FIG. 26 is a modified overall configuration diagram of a switching power supply device according to a fourth Example belonging to an embodiment of the present disclosure.

### DETAILED DESCRIPTION

Examples of embodiments of the present disclosure will be described in detail below with reference to the drawings. Throughout the referred drawings, the same parts are denoted by the same reference numerals, and duplicate explanation thereof will not be repeated in principle. In the present disclosure, for the sake of simplification of description, by describing a symbol or a code that refers to information, a signal, a physical quantity, a functional part, a circuit, an element, a part, etc., the designations of the information, the signal, the physical quantity, the functional part, the circuit, the element, the part, etc., corresponding to the symbol or the code may be omitted or abbreviated.

First, an explanation for some terms used in the description of the embodiments of the present disclosure is provided. IC is an abbreviation for integrated circuit. The ground refers to a reference conductive portion having a potential of 0 V (zero volts) which is a reference or refers to the potential of 0 V itself. The reference conductive portion may be formed of a conductor such as metal. The potential of 0 V may be referred to as a ground potential. In the embodiments of the present disclosure, a voltage denoted without any particular reference represents the potential with respect to the ground.

A level refers to the level of potential, and a high level has a higher potential than a low level for any signal or voltage of interest. For any signal or voltage of interest, strictly speaking, the signal or voltage of a high level means that the level of the signal or voltage is a high level, and strictly speaking, the signal or voltage of a low level means that the level of the signal or voltage is a low level. The level for a signal is sometimes expressed as a signal level, and the level for a voltage is sometimes expressed as a voltage level. For any signal that takes a signal level of a high level or a low level, a period in which the level of the signal is a high level is called a high level period, and a period in which the level of the signal is a low level is called a low level period. The same is true for any voltage that takes a voltage level of a high level or a low level.

For any signal or voltage of interest, switching from a low level to a high level is called an up-edge, and a timing of switching from a low level to a high level is called an up-edge timing. The up-edge may be read as a rising edge. Similarly, for any signal or voltage of interest, switching from a high level to a low level is called a down-edge, and a timing of switching from a high level to a low level is called a down-edge timing. The down-edge can be read as a falling edge.

For any transistor configured as a FET (Field Effect Transistor), including a MOSFET, a turn-on state refers to a state in which the drain and source of the transistor are electrically connected, and a turn-off state refers to a state in which the drain and source of the transistor are electrically disconnected (cut-off state). The same applies to transistors that are not classified as FETs. Unless otherwise specified, a MOSFET is regarded as an enhancement type MOSFET. MOSFET is an abbreviation of “Metal-Oxide-Semiconductor Field-Effect Transistor.” Moreover, it may be considered that the back gate is short-circuited to the source in any MOSFET unless otherwise specified.

An arbitrary switch can be composed of one or more FETs (Field Effect Transistors). When a certain switch is in a turn-on state, there is conduction across the switch, and when a switch is in a turn-off state, there is no conduction across the switch.

Hereinafter, for any transistor or switch, a turn-on state and a turn-off state may be simply expressed as on and off. For any transistor or switch, switching from a turn-off state to a turn-on state is expressed as turn on, and switching from a turn-on state to a turn-off state is expressed as turn off. Further, for any transistor or switch, a period during which the transistor or switch is in a turn-on state may be called a turn-on period, and a period during which the transistor or switch is in a turn-off state may be called a turn-off period.

A connection between a plurality of parts forming a circuit, such as arbitrary circuit elements, wirings, and nodes, may be understood to refer to an electrical connection unless otherwise specified.

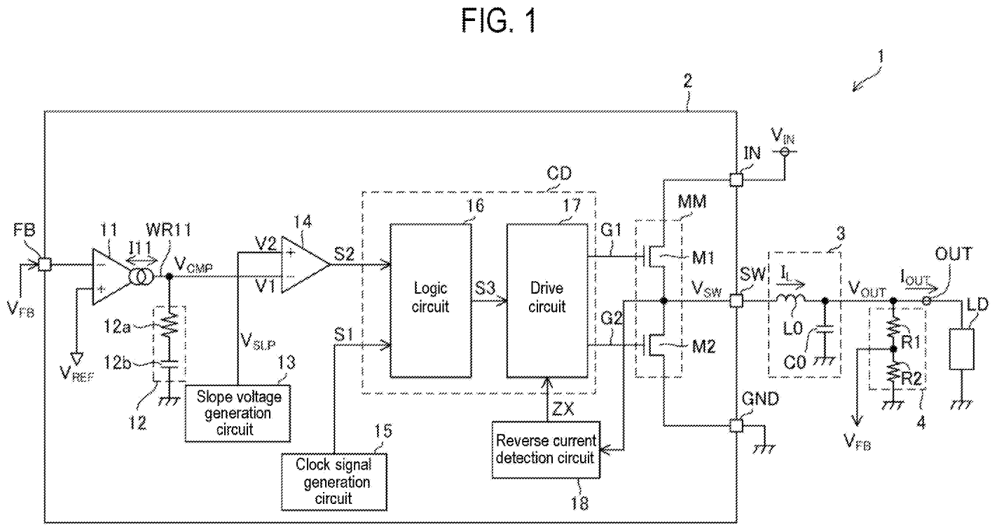

Embodiments of the present disclosure will be described. FIG. 1 is an overall configuration diagram of a switching power supply device 1 according to an embodiment of the present disclosure. The switching power supply device 1 of FIG. 1 includes a power supply IC 2 which is a switching power supply circuit (switching power supply semiconductor device) and a plurality of discrete components which is externally connected to the power supply IC 2. The plurality of discrete components provided in the switching power supply device 1 includes an output inductor L0, an output capacitor C0, and feedback resistors R1 and R2. The switching power supply device 1 is configured as a step-down switching power supply device (DC/DC converter) that generates a desired output voltage V_{OUT} from an externally supplied input voltage V_{IN}. The output voltage V_{OUT} is generated at an output terminal OUT. That is, the output terminal OUT is an application terminal of the output voltage V_{OUT} (a terminal to which the output voltage V_{OUT} is applied). The output voltage V_{OUT} is supplied to a load LD connected to the output terminal OUT.

The input voltage V_{IN} and the output voltage V_{OUT} are positive DC voltages, and the output voltage V_{OUT} is lower than the input voltage V_{IN}. For example, when the input voltage V_{IN} is 12 V, the output voltage V_{OUT} can be stabilized at a desired positive voltage value (for example, 3.3 V or 5 V) below 12 V by adjusting the resistance values of the feedback resistors R1 and R2. A current supplied to the load LD through the output terminal OUT is referred to as an output current I_{OUT}. The output current I_{OUT} can also be referred to as a load current.

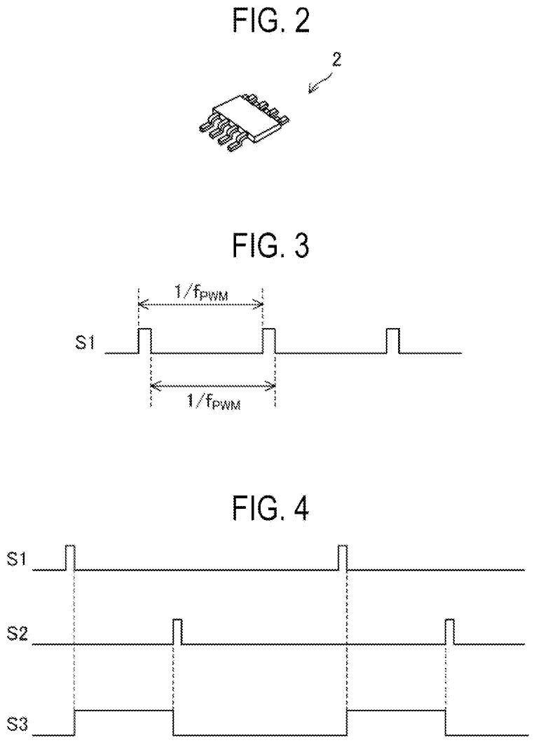

FIG. 2 is an external perspective view of the power supply IC 2. The power supply IC 2 is an electronic component including a semiconductor chip having a semiconductor integrated circuit formed on a semiconductor substrate, a housing (package) containing the semiconductor chip, and a plurality of external terminals exposed from the housing to the outside of the power supply IC 2. The power supply IC 2 is formed by enclosing the semiconductor chip in the housing (package) made of resin. Further, the number of external terminals of the power supply IC 2 and the type of the housing of the power supply IC 2 shown in FIG. 2 are merely examples, and they can be designed arbitrarily.

In FIG. 1, although an input terminal IN, a switch terminal SW, a ground terminal GND, and a feedback terminal FB are shown as parts of the plurality of external terminals provided in the power supply IC 2, other external terminals (for example, an enable terminal, a power good terminal, and a boot terminal) may also be provided in the power supply IC 2.

An external configuration of the power supply IC 2 will be described. The input voltage V_{IN} is supplied to the input terminal IN from the outside of the power supply IC 2. The output inductor L0 is interposed in series between the switch terminal SW and the output terminal OUT. That is, one end of the output inductor L0 is connected to the switch terminal SW, and the other end of the output inductor L0 is connected to the output terminal OUT. Further, the output terminal OUT is connected to the ground via the output capacitor C0. Furthermore, the output terminal OUT is connected to one end of the feedback resistor R1, and the other end of the feedback resistor R1 is connected to the ground via the feedback resistor R2. A connection node between the feedback resistors R1 and R2 is connected to the feedback terminal FB. The ground terminal GND is connected to the ground. A current flowing through the output inductor L0 is referred to as an inductor current I_{L}. The inductor current I_{L}, which flows in a direction directed from the switch terminal SW to the output terminal OUT, has a positive polarity, and the reverse inductor current I_{L} has a negative polarity.

An internal configuration of the power supply IC 2 will be described. The power supply IC 2 includes an output stage circuit MM, an error amplifier 11, a phase compensation circuit 12, a slope voltage generation circuit 13, a comparator 14, a clock signal generation circuit 15, a logic circuit 16, a drive circuit 17, and a reverse current detection circuit 18.

The output stage circuit MM includes transistors M1 and M2 configured as N-channel MOSFETs (Metal Oxide Semiconductor Field Effect Transistors). The transistors M1 and M2 are a pair of switching elements connected in series between the input terminal IN and the ground terminal GND (in other words, the ground). As they are switching-driven, the input voltage V_{IN} is switched so that a rectangular wave-shaped switch voltage V_{SW} appears at the switch terminal SW. The transistor M1 is provided on the higher potential side than the transistor M2. In other words, the transistor M2 is provided on the lower potential side than the transistor Ml. Specifically, the drain of the transistor M1 is connected to the input terminal IN, which is the application terminal of the input voltage V_{IN}, and receives the input voltage V_{IN}. The source of the transistor M1 and the drain of the transistor M2 are connected in common to the switch terminal SW. The source of the transistor M2 is connected to the ground. However, a resistor for current detection may be inserted between the source of the transistor M2 and the ground.

The transistor M1 functions as an output transistor, and the transistor M2 functions as a synchronous rectification transistor. Hereinafter, the transistor M1 is referred to as an output transistor, and the transistor M2 is referred to as a synchronous rectification transistor M2. The output inductor L0 and the output capacitor C0 constitute a rectifying/smoothing circuit 3 that rectifies and smoothes the rectangular wave-shaped switch voltage V_{SW} appearing at the switch terminal SW and generates the output voltage V_{OUT}. The feedback resistors R1 and R2 constitute a feedback voltage generation circuit 4 that divides the output voltage V_{OUT} and generates a feedback voltage V_{FB} corresponding to the output voltage V_{OUT}. The feedback voltage V_{FB} is input to the feedback terminal FB by connecting the connection node between the feedback resistors R1 and R2 to the feedback terminal FB.

Gate signals G1 and G2 are supplied as drive signals to the gates of the transistors M1 and M2, respectively, and the transistors M1 and M2 are turned on/off according to the gate signals G1 and G2. When the gate signal G1 is at a high level, the transistor M1 is turned on, and when the gate signal G1 is at a low level, the transistor M1 is turned off. Similarly, when the gate signal G2 is at a high level, the transistor M2 is turned on, and when the gate signal G2 is at a low level, the transistor M2 is turned off. Basically, the transistors M1 and M2 are alternately turned on/off, but both of the transistors M1 and M2 may be maintained in a turned-off state. That is, the state of the output stage circuit MM is one selected from the group of an output high state, an output low state, and a Hi-Z state. The Hi-Z state can also be called an output off state. In the output high state, the transistors M1 and M2 are turned on and off, respectively. In the output low state, the transistors M1 and M2 are turned off and on, respectively. In the Hi-Z state, both of the transistors M1 and M2 are turned off. There is no case where both of the transistors M1 and M2 are turned on.

The power supply IC 2 controls the turn-on/off states of the transistors M1 and M2 through a level control of the gate signals G1 and G2 based on the feedback voltage V_{FB}, thereby generating the output voltage V_{OUT} corresponding to the feedback voltage V_{FB} at the output terminal OUT.

Although not shown specifically, the power supply IC 2 is provided with an internal power supply circuit that generates an internal power supply voltage based on the input voltage V_{IN}, and each circuit in the power supply IC 2 is driven based on the internal power supply voltage. The gate signal G2 is a signal based on the ground potential, while the gate signal G1 is a signal based on the potential of the switch terminal SW. The low-level gate signal G1 has the potential of the switch terminal SW, and the high-level gate signal G1 is higher than the potential of the switch terminal SW by a predetermined voltage. Here, the predetermined voltage is greater than a gate threshold voltage of the transistor M1. A well-known bootstrap circuit (not shown) can be used to generate a boosted power supply for generating the gate signal G1.

The error amplifier 11 is a current output-type transconductance amplifier. The error amplifier 11 includes an inverting input terminal, a non-inverting input terminal, and an output terminal. The inverting input terminal of the error amplifier 11 is connected to the feedback terminal FB to receive the feedback voltage V_{FB}. A predetermined reference voltage V_{REF} is supplied to the non-inverting input terminal of the error amplifier 11. The reference voltage V_{REF} is a DC voltage having a predetermined positive voltage value and is generated by a reference voltage generation circuit (not shown) within the power supply IC 2. The output terminal of the error amplifier 11 is connected to a wiring WR11.

The error amplifier 11 outputs a current signal I11, which corresponds to the difference between the feedback voltage V_{FB} and the reference voltage V_{REF}, from the output terminal of the error amplifier 11 so that an error voltage V_{CMP}, which corresponds to the difference between the feedback voltage V_{FB} and the reference voltage V_{REF}, is generated on the wiring WR11. Charges due to the current signal I11 are input/output to/from the wiring WR11. Specifically, when the feedback voltage V_{FB} is lower than the reference voltage V_{REF}, the error amplifier 11 outputs a current by the current signal I11 from the error amplifier 11 toward the wiring WR11 so that the potential of the wiring WR11 rises. When the feedback voltage V_{FB} is higher than the reference voltage V_{REF}, the error amplifier 11 draws a current by the current signal I11 from the wiring WR11 toward the error amplifier 11 so that the potential of the wiring WR11 falls. As the absolute value of the difference between feedback voltage V_{FB} and the reference voltage V_{REF} increases, the magnitude of the current by the current signal I11 also increases.

When the power supply IC 2 is started, a soft-start voltage that gently rises from 0 V toward a voltage exceeding the reference voltage V_{REF} may be generated in the power supply IC 2. In this case, the error amplifier 11 compares the lower one of the reference voltage V_{REF} and the soft-start voltage with the feedback voltage V_{FB} and generates the current signal I11 based on the comparison result. However, in the present embodiment, a state after the soft-start voltage becomes higher than the reference voltage V_{REF} is considered, and the presence of the soft start voltage is ignored below.

The phase compensation circuit 12 is provided between the wiring WR11 and the ground, receives the input of the current signal I11, and compensates the phase of the error voltage Vcmp. The phase compensation circuit 12 includes a series circuit of a resistor 12a and a capacitor 12b. Specifically, one end of the resistor 12a is connected to the wiring WR11, the other end of the resistor 12a is connected to one end of the capacitor 12b, and the other end of the capacitor 12b is connected to the ground. By appropriately setting the resistance value of the resistor 12a and the capacitance value of the capacitor 12b, the phase of the error voltage V_{CMP} can be compensated so that it is possible to prevent oscillation of an output feedback loop.

The slope voltage generation circuit 13 generates and outputs a slope voltage V_{SLP}. The internal configuration of the slope voltage generation circuit 13 and the characteristics of the slope voltage V_{SLP} will be described later.

The comparator 14 includes an inverting input terminal that receives a voltage V1, a non-inverting input terminal that receives a voltage V2, and an output terminal. The voltage V1 is a first comparison voltage and the voltage V2 is a second comparison voltage. The comparator 14 compares the voltages V1 and V2 and outputs a signal S2 indicative of the comparison result (hereinafter referred to as comparison result signal S2) from the output terminal of the comparator 14. The comparison result signal S2 is a binary signal taking a signal level of a high level or a low level. The comparator 14 outputs the comparison result signal S2 of a high level when “V2>V1” is established (that is, when the voltage V2 is higher than the voltage V1), and outputs the comparison result signal S2 of a low level when “V2<V1” is established (that is, when the voltage V1 is higher than the voltage V2). When “V2=V1” is established, the comparison result signal S2 has a high level or a low level.

The error voltage V_{CMP} functions as the voltage V1 in the power supply IC 2. That is, the inverting input terminal of the comparator 14 is connected to the wiring WR11 and receives the error voltage V_{CMP} as the voltage V1. The slope voltage V_{SLP} functions as the voltage V2 in the power supply IC 2. That is, the non-inverting input terminal of the comparator 14 receives the slope voltage V_{SLP} as the voltage V2. However, the sum voltage of the slope voltage V_{SLP} and a voltage corresponding to the inductor current I_{L} may be used as the voltage V2. Hereinafter, unless otherwise specified, the slope voltage V_{SLP} itself is considered as the voltage V2. The comparison result signal S2 is input to the slope voltage generation circuit 13.

The clock signal generation circuit 15 generates and outputs a clock signal S1 having a predetermined frequency f_{PWM}. FIG. 3 shows the waveform of the clock signal S1. The clock signal S1 is a signal in which a pulse is generated at the frequency f_{PWM}. That is, a pulse, which becomes a high level for a very short time every cycle of the clock signal S1, is generated in the clock signal S1. The length of one cycle of the clock signal S1 is the reciprocal of the frequency f_{PWM}. The level of the clock signal S1 transitions from a low level to a high level at an interval of the reciprocal of the frequency f_{PWM}, and the level of the clock signal S1 transitions from a high level to a low level at an interval of the reciprocal of the frequency f_{PWM}. The reciprocal of the frequency f_{PWM} is hereinafter referred to as a PWM cycle.

The logic circuit 16 generates and outputs a control signal S3 based on the clock signal S1 and the comparison result signal S2. The control signal S3 is a binary signal taking a signal level of a high level or a low level. The relationship between the signals S1 to S3 will be described with reference to FIG. 4. When the down-edge of the clock signal S1 occurs while the comparison result signal S2 and the control signal S3 are at a low level, the logic circuit 16 switches the level of the control signal S3 from a low level to a high level in synchronization with the down-edge of the clock signal S1. Thereafter, when an up-edge occurs in the comparison result signal S2, the logic circuit 16 switches the level of the control signal S3 from a high level to a low level in synchronization with the up-edge of the comparison result signal S2.

The drive circuit 17 individually turns on or off the transistors M1 and M2 by supplying the gate signals G1 and G2 corresponding to the control signal S3 to the gates of the transistors M1 and M2, respectively. Under the premise that a reverse current detection signal ZX is at a low level, the drive circuit 17 brings the output stage circuit MM into the output low state by setting the gate signal G1 to a high level and the gate signal G2 to a low level during the high level period of the control signal S3, and brings the output stage circuit MM into the output high state by setting the gate signal G1 to the low level and the gate signal G2 to the high level during the low level period of the control signal S3. When the reverse current detection signal ZX is switched from the low level to the high level while controlling the output stage circuit MM to the low output state, the drive circuit 17 switches the state of the output stage circuit MM from the low output state to the Hi-Z state (output off state), and keeps the output stage circuit MM in the Hi-Z state until the control signal S3 is switched to the high level at the next time.

The logic circuit 16 and the drive circuit 17 constitute a control drive circuit CD that controls the output stage circuit MM based on the clock signal S1 and the comparison result signal S2.

The reverse current detection circuit 18 is connected to the switch terminal SW, detects a reverse current of the inductor current I_{L} based on the switch voltage V_{SW}, and generates and outputs the reverse current detection signal ZX indicative of the detection result. The reverse current detection signal ZX is a binary signal taking a signal level of a high level or low level. The reverse current of the inductor current I_{L} means that the inductor current I_{L} flows from the output inductor L0 toward the ground through the switch terminal SW and the transistor M2 when the output stage circuit MM is in the output low state. In principle, the reverse current detection circuit 18 sets the reverse current detection signal ZX to a low level, switches the level of the reverse current detection signal ZX to a high level when the reverse current of the inductor current I_{L} is detected, and latches it at the high level. Thereafter, the reverse current detection circuit 18 releases the latch in response to the up-edge of the control signal S3 or the up-edge of the gate signal G1, and returns the level of the reverse current detection signal ZX to the low level. For example, the reverse current detection circuit 18 can monitor switching of the polarity of the switch voltage V_{SW} from negative to positive during a period in which the output stage circuit MM is in the output low state, and determine that the reverse current of the inductor current I_{L} has been generated when the switching is detected. An operation of blocking the reverse current by switching the output stage circuit MM from the output low state to the Hi-Z state when the reverse current of the inductor current I_{L} is detected is hereinafter referred to as a reverse current blocking operation.

When the state of the output stage circuit MM is the output high state, the inductor current I_{L} is supplied from the input terminal IN to the output inductor L0 through the channel of the output transistor M1 and the switch terminal SW. After that, by switching the state of the output stage circuit MM to the output low state, the inductor current I_{L} is supplied from the ground terminal GND to the output inductor L0 through the channel of the synchronous rectification transistor M2 and the switch terminal SW. By alternately switching the output stage circuit MM between the output high state and the output low state, the output voltage V_{OUT} can be generated from the input voltage V_{IN}.

### First PWM Control (Continuous Current Mode)

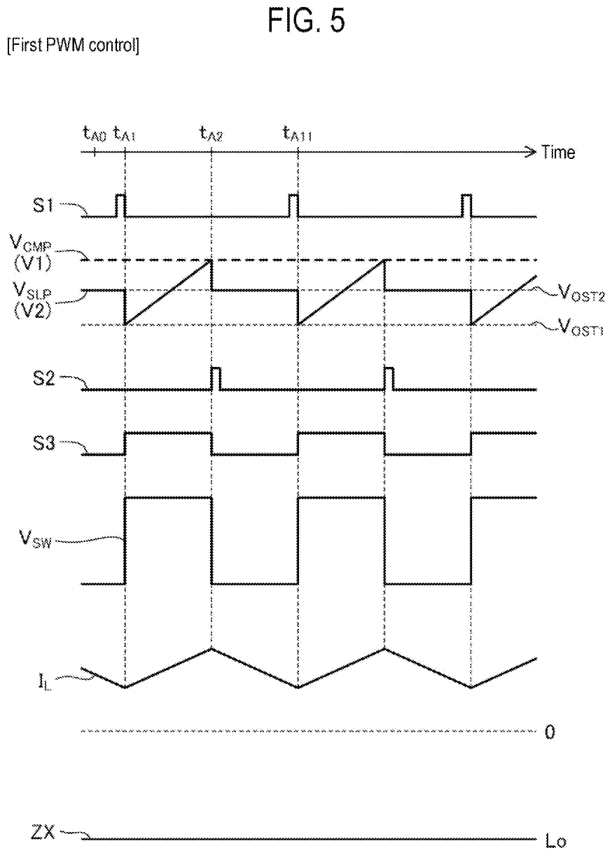

A first PWM control that can be performed by the switching power supply device 1 and the power supply IC 2 will be described with reference to FIG. 5. FIG. 5 is a timing chart of the first PWM control. PWM is an abbreviation for Pulse Width Modulation. The first PWM control is a PWM control that is performed in a continuous current mode, and is a PWM control that does not involve a reverse current blocking operation. In the first PWM control, a switching operation in which the transistors M1 and M2 are alternately turned on and off is cyclically performed, and the cycle of the switching operation (switching cycle) matches the PWM cycle (the same applies to second PWM cycle to be described later). In the continuous current mode, the inductor current I_{L} always flows from the switch terminal SW toward the output terminal OUT. When the output current I_{OUT} is maintained at a sufficiently large current value, the first PWM control in the continuous current mode is continuously executed.

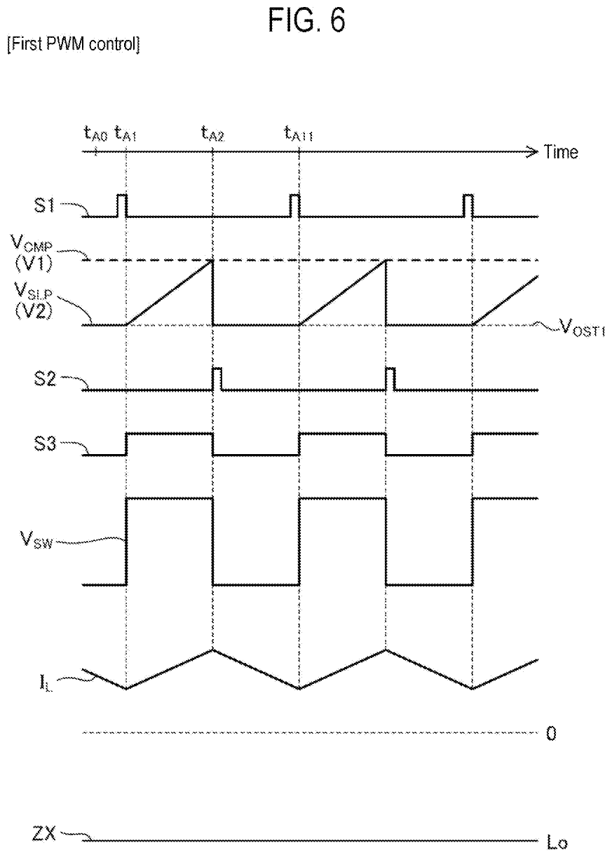

In the first PWM control, the control signal S3 is a pulse width modulated signal with the frequency f_{PWM}. Therefore, in the first PWM control, the transistors M1 and M2 are switching-driven at the frequency f_{PWM}, and as a result, the switch voltage V_{SW} has the frequency f_{PWM}. In the first PWM control, by adjusting the length of the ON period of the control signal S3 in each cycle, the output voltage V_{OUT} is stabilized at a target voltage V_{TG} (not shown in FIG. 5). The target voltage V_{TG} is determined by a ratio between the output voltage V_{OUT} and the feedback voltage V_{FB} and by the reference voltage V_{REF}. A first offset voltage V_{OST1} and a second offset voltage V_{OST2} shown in FIG. 5 are generated by the slope voltage generation circuit 13. In the example of FIG. 5, it is assumed that the offset voltages V_{OST1} and V_{OST2} are always lower than the error voltage V_{CMP} during the period in which the first PWM control is performed. Here, “V_{OST1}<V_{OST2}” is established. Although the first offset voltage V_{OST1} actually fluctuates, FIG. 5 shows as if the first offset voltage V_{OST1} is constant (the same applies to FIGS. 6 to 9 to be described later).

In the continuous current mode, the reverse current detection signal ZX is maintained at a low level. At timing t_{A0}, the comparison result signal S2 and the control signal S3 are at a low level. A down-edge occurs in the clock signal S1 at timing t_{A1} after timing t_{A0}. The down-edge of the clock signal S1 causes generation of the up-edge of the control signal S3, thereby switching the output stage circuit MM from the output low state to the output high state. During the period in which the output stage circuit MM is maintained in the output high state (that is, during the turn-on period of the output transistor M1), the inductor current I_{L} increases. In the continuous current mode, the inductor current I_{L} increases from the state of “I_{L}>0” during the period in which the output stage circuit MM is maintained in the output high state.

On the other hand, the slope voltage generation circuit 13 monotonically increases the slope voltage V_{SLP} from the first offset voltage V_{OST1} with a slope corresponding to the input voltage V_{IN} during the turn-on period of the output transistor M1. As a result, the slope voltage V_{SLP} reaches the error voltage V_{CMP} at timing t_{A2} after timing t_{A1}. Specifically, at timing t_{A2}, the established state of “V_{SLP}<V_{CMP}” is switched to the established state of “V_{SLP}>V_{CMP}.” An up-edge occurs in the comparison result signal S2 in synchronization with this switching. Further, “V_{SLP}<V_{CMP}” is continuously established from timing t_{A1} to immediately before timing t_{A2}.

A down-edge occurs in the control signal S3 in response to the up-edge of the comparison result signal S2 at timing t_{A2}, thereby switching the output stage circuit MM from the output high state to the output low state. Further, the slope voltage generation circuit 13 sets the slope voltage V_{SLP} to the second offset voltage V_{OST2} in response to the up-edge of the comparison result signal S2. In the example of FIG. 5, “V_{OST2}<V_{CMP}.” Therefore, after timing t_{A2}, the level of the comparison result signal S2 quickly returns to the low level. During the period in which the output stage circuit MM is maintained in the output low state (that is, during the turn-on period of the synchronous rectification transistor M2), the inductor current I_{L} decreases. After that, at timing t_{A11} after the time corresponding to the PWM cycle (that is, the time corresponding to the reciprocal of the frequency f_{PWM}) has passed since timing t_{A1}, a down-edge again occurs in the clock signal S1. As a result, the operation triggered by the down-edge of the clock signal S1 is repeated.

In the first PWM control shown in FIG. 5, the slope voltage V_{SLP} is fixed at the second offset voltage V_{OST2} during the turn-off period of the output transistor M1. However, when the first PWM control is performed, the slope voltage V_{SLP} may be set to the first offset voltage V_{OST1} during all or a part of the turn-off period of the output transistor M1.

FIG. 6 shows another example of the first PWM control. In the first PWM control shown in FIG. 6, the first offset voltage V_{OST1} is set to the slope voltage V_{SLP} during the entire turn-off period of the output transistor M1. That is, the slope voltage generation circuit 13 related to the first PWM control of FIG. 6 sharply lowers the slope voltage V_{SLP} to the first offset voltage V_{OST1}, but not the second offset voltage V_{OST2}, in response to the up-edge of the comparison result signal S2.

### Second PWM Control (Discontinuous Current Mode)

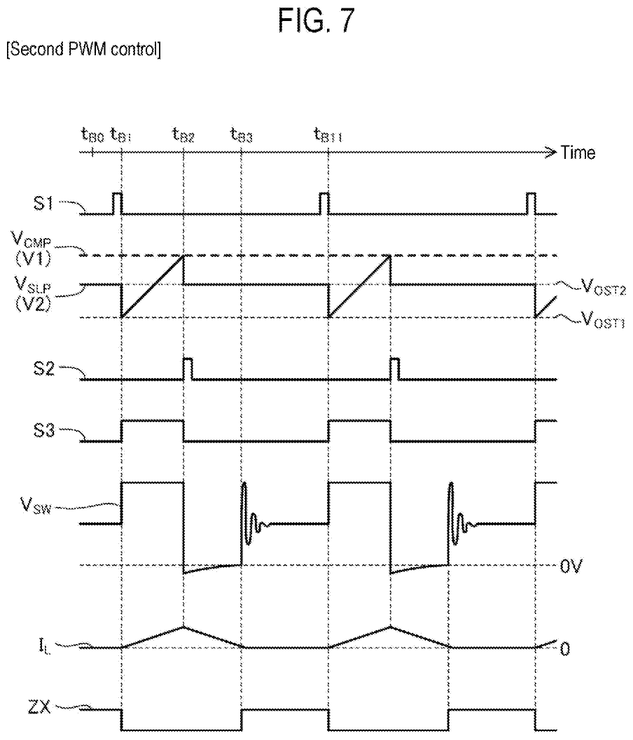

A second PWM control that can be performed by the switching power supply device 1 and the power supply IC 2 will be described with reference to FIG. 7. FIG. 7 is a timing chart of the second PWM control. The second PWM control is a PWM control that is performed in a discontinuous current mode, and is a PWM control that involves a reverse current blocking operation. In a light load condition where the output current I_{OUT} is relatively small, the second PWM control by the discontinuous current mode can be performed. In the discontinuous current mode, a period in which the inductor current I_{L} flows from the switch terminal SW toward the output terminal OUT and a period in which the inductor current I_{L} becomes zero are alternated. Similar to the first PWM control, in the second PWM control, the control signal S3 is a pulse width modulated signal with the frequency f_{PWM}. Therefore, in the second PWM control, the transistors M1 and M2 are switching-driven at the frequency f_{PWM}, and as a result, the switch voltage V_{SW} has the frequency f_{PWM}. In the example of FIG. 7, it is assumed that the offset voltages V_{OST1} and V_{OST2} are always lower than the error voltage V_{CMP} during the period in which the second PWM control is performed. Here, “V_{OST1}<V_{OST2}” is established.

At timing t_{B0}, the comparison result signal S2 and the control signal S3 are at a low level, and the reverse current detection signal ZX is at a high level. A down-edge occurs in the clock signal S1 at timing t_{B1} after timing t_{B0}. An up-edge occurs in the control signal S3 in response to the down-edge of the clock signal S1. The up-edge of the control signal S3 or the up-edge of the gate signal G1 based thereon releases the latch of the level of the reverse current detection signal ZX to the high level, and the level of the reverse current detection signal ZX transitions to the low level. Further, the output stage circuit MM switches from the output low state to the output high state based on the up-edge of the control signal S3. During the period in which the output stage circuit MM is maintained in the output high state (that is, during the turn-on period of the output transistor M1), the inductor current I_{L} increases. In the second PWM control in the discontinuous current mode, the inductor current I_{L} increases from zero during the period in which the output stage circuit MM is maintained in the output high state.

On the other hand, the slope voltage generation circuit 13 monotonically increases the slope voltage V_{SLP} from the first offset voltage V_{OST1} with a slope corresponding to the input voltage V_{IN} during the turn-on period of the output transistor M1. As a result, the slope voltage V_{SLP} reaches the error voltage V_{CMP} at timing t_{B2} after timing t_{B1}. Specifically, at timing t_{B2}, the established state of “V_{SLP}<V_{CMP}” is switched to the established state of “V_{SLP}>V_{CMP}.” An up-edge occurs in the comparison result signal S2 in synchronization with this switching. Further, “V_{SLP}<V_{CMP}” is continuously established from timing t_{B1} to immediately before timing t_{B2}.

A down-edge occurs in the control signal S3 in response to the up-edge of the comparison result signal S2 at timing t_{B2}, thereby switching the output stage circuit MM from the output high state to the output low state. Further, the slope voltage generation circuit 13 sets the slope voltage V_{SLP} to the second offset voltage V_{OST2} in response to the up-edge of the comparison result signal S2. In the example of FIG. 7, “V_{OST2}<V_{CMP}.” Therefore, after timing t_{B2}, the level of the comparison result signal S2 quickly returns to the low level. During the period in which the output stage circuit MM is maintained in the output low state (that is, during the turn-on period of the synchronous rectification transistor M2), the inductor current I_{L} decreases.

When the magnitude of the inductor current I_{L} flowing from the switch terminal SW to the output terminal OUT decreases to zero, the polarity of the inductor current I_{L} is inverted from positive to negative by the action of the output inductor L0. The timing of this inversion is timing t_{B3} after timing t_{B2}. At timing t_{B3}, the reverse current detection circuit 18 detects the reverse current of the inductor current I_{L}, so that the reverse current detection signal ZX switches from the low level to the high level and is latched at the high level. The drive circuit 17 receives the reverse current detection signal ZX of the high level and switches the output stage circuit MM from the output low state to the Hi-Z state. As a result, the reverse current of the inductor current I_{L} is quickly blocked, so that the efficiency drop can be suppressed at the time of light load.

Thereafter, at timing t_{B11} when the time for the PWM cycle (that is, the time for the reciprocal of the frequency f_{PWM}) has elapsed from timing t_{B1}, a down-edge again occurs in the clock signal S1. As a result, the operation triggered by the down-edge of the clock signal S1 is repeated.

In the second PWM control shown in FIG. 7, the slope voltage V_{SLP} is fixed at the second offset voltage V_{OST2} during the turn-off period of the output transistor M1. However, when the second PWM control is performed, the slope voltage V_{SLP} may be set to the first offset voltage V_{OST1} during all or a part of the turn-off period of the output transistor M1.

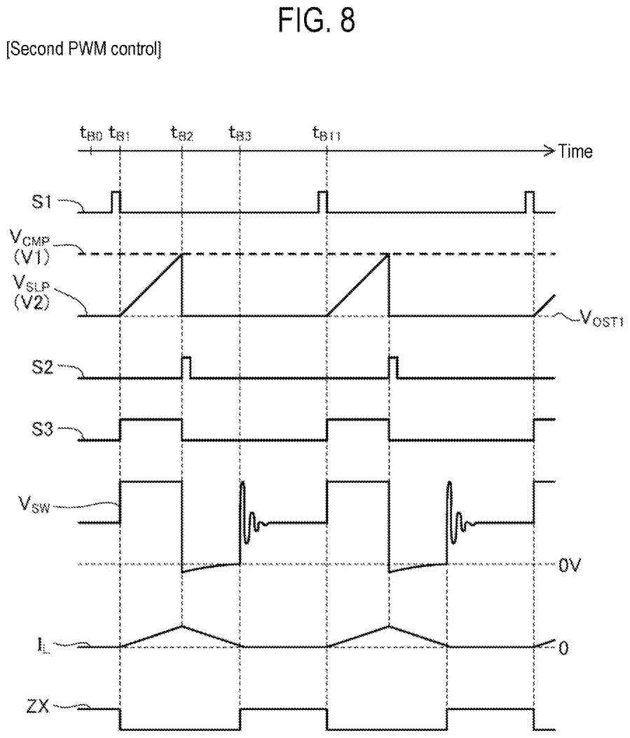

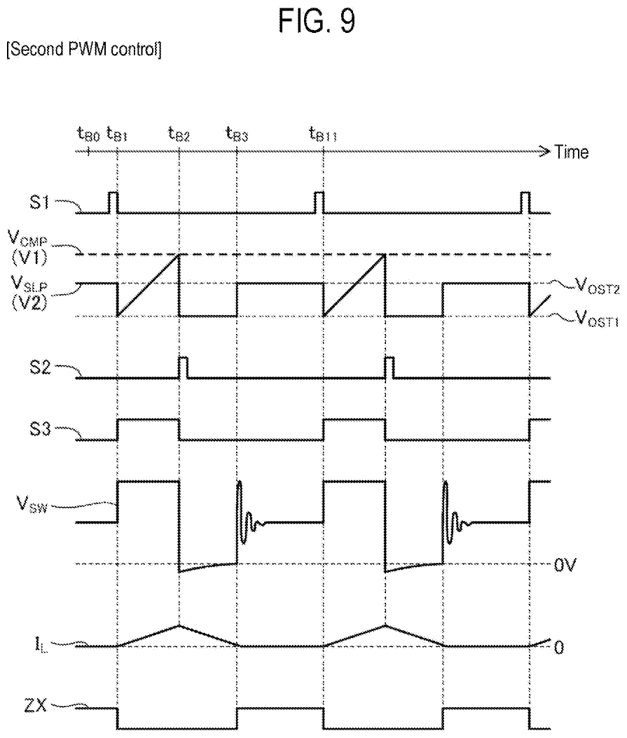

FIG. 8 shows another example of the second PWM control. In the second PWM control shown in FIG. 8, the first offset voltage V_{OST1} is set to the slope voltage V_{SLP} during the entire turn-off period of the output transistor M1 (thus, in the output low state and Hi-Z state of the output stage circuit MM). That is, the slope voltage generation circuit 13 related to the second PWM control in FIG. 8 sharply lowers the slope voltage V_{SLP} to the first offset voltage V_{OST1}, but not the second offset voltage V_{OST2}, by the up-edge of the comparison result signal S2 (the same applies to second PWM control of FIG. 9).

FIG. 9 shows still another example of the second PWM control. In the second PWM control shown in FIG. 9, the first offset voltage V_{OST1} is set to the slope voltage V_{SLP} during a part of the turn-off period of the output transistor M1. Specifically, in the second PWM control shown in FIG. 9, the first offset voltage V_{OST1} is set to the slope voltage V_{SLP} when the output stage circuit MM is in the output low state, and the second offset voltage V_{OST2} is set to the slope voltage V_{SLP} when the output stage circuit MM is in the Hi-Z state.

### Basic Unit Operation

In the first or second PWM control, the switching power supply device 1 and the power supply IC 2 repeatedly perform a basic unit operation. The basic unit operation is an operation that is started in response to the down-edge of the clock signal S1, and is an operation that is executed for the time of the reciprocal of the frequency f_{PWM}. Therefore, for example, an operation from timing t_{A1} to immediately before timing t_{A11} in FIG. 5 or 6 is a basic unit operation related to the first PWM control, and an operation from timing t_{B1} to immediately before timing t_{B11} in FIG. 7, 8, or 9 is a basic unit operation related to the second PWM control.

In the basic unit operation, the control drive circuit CD switches the output stage circuit MM from the output low state or Hi-Z state (output off state) to the output high state in response to a change of the level of the clock signal S1 from a high level to a low level. After that, the control drive circuit CD switches the output stage circuit MM from the output high state to the output low state in response to the input of the comparison result signal S2 indicating that the voltage V2 (the slope voltage V_{SLP}) has reached the voltage V1 (the error voltage V_{CMP}), that is, in response to the up-edge of the comparison result signal S2. Further, after that, the control drive circuit CD switches the state of the output stage circuit MM from the output low state to the Hi-Z state (output off state) when the reverse current of the inductor current I_{L} is detected. This switching is performed in the second PWM control related to the discontinuous current mode, but not in the first PWM control related to the continuous current mode.

### Skip Control

When the output current I_{OUT} is considerably small, once the output stage circuit MM is set to the output high state, the output voltage V_{OUT} is maintained near the target voltage V_{TG} for a long time. Considering this, the control drive circuit CD can perform a skip control below. The skip control is expected to improve efficiency at a light load.

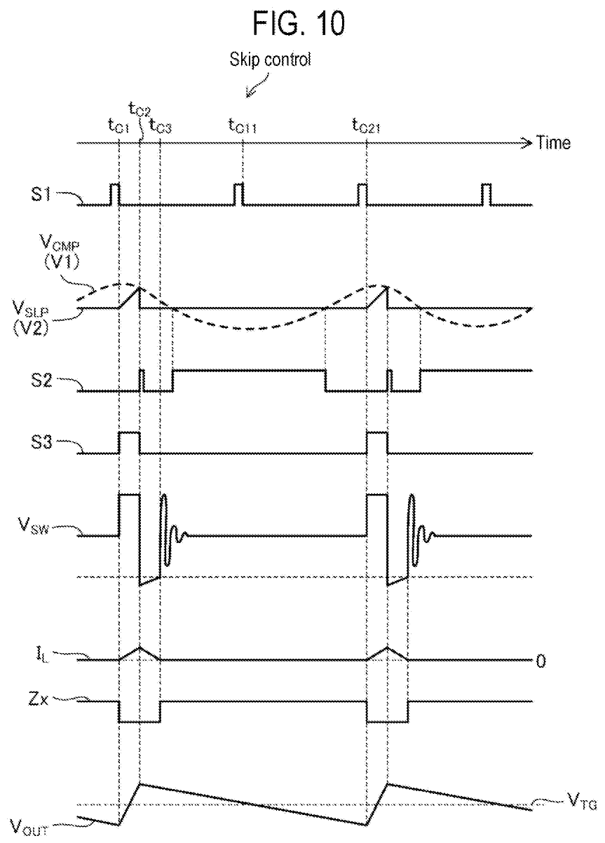

The skip control will be described with reference to FIG. 10. FIG. 10 is a timing chart of the skip control, and shows various signal waveforms when the skip control is performed. In the examples of FIGS. 5 to 9, it is assumed that the error voltage V_{CMP} is maintained substantially constant, but in reality the error voltage V_{CMP} may fluctuate with a fluctuation in the output voltage V_{OUT}. Further, in the example of FIG. 10, it is assumed that the slope voltage V_{SLP} is maintained at a predetermined reset level in the output low state and Hi-Z state of the output stage circuit MM for the sake of preventing complication of illustration and for the sake of convenience of description.

In the example of FIG. 10, a down-edge occurs in the clock signal S1 at timing t_{C1}, and an up-edge occurs in the control signal S3 in response to the down-edge of the clock signal S1. It is assumed that “V_{SLP}<V_{CMP}” at timing t_{C1}. It is also assumed that the reverse current detection signal ZX is latched to a high level immediately before timing t_{C1} and the state of the output stage circuit MM is the Hi-Z state. The up-edge of the control signal S3 at timing t_{C1} or the up-edge of the gate signal G1 based thereon releases the latch of the level of the reverse current detection signal ZX which is at the high level, and the level of the reverse current detection signal ZX transitions to the low level. Further, the output stage circuit MM switches from the Hi-Z state to the output high state based on the up-edge of the control signal S3. During the period in which the output stage circuit MM is maintained in the output high state (that is, during the turn-on period of the output transistor M1), the inductor current I_{L} increases. In the example of FIG. 10, the inductor current I_{L} increases from zero during the period in which the output stage circuit MM is maintained in the output high state.

On the other hand, the slope voltage generation circuit 13 monotonically increases the slope voltage V_{SLP} from the reset level with a slope corresponding to the input voltage V_{IN} during the turn-on period of the output transistor M1. As a result, the slope voltage V_{SLP} reaches the error voltage V_{CMP} at timing t_{C2} after timing t_{C1}. Specifically, at timing t_{C2}, the established state of “V_{SLP}<V_{CMP}” is switched to the established state of “V_{SLP}>V_{CMP}.” An up-edge occurs in the comparison result signal S2 in synchronization with this switching. Further, “V_{SLP}<V_{CMP}” is continuously established from timing t_{C1} to immediately before timing t_{C2}.

A down-edge occurs in the control signal S3 in response to the up-edge of the comparison result signal S2 at timing t_{C2}, thereby switching the output stage circuit MM from the output high state to the output low state. Further, in the example of FIG. 10, the slope voltage generation circuit 13 sharply lowers the slope voltage V_{SLP} to the reset level in response to the up-edge of the comparison result signal S2. Therefore, after timing t_{C2}, the level of the comparison result signal S2 quickly returns to the low level. During the period in which the output stage circuit MM is maintained in the output low state (that is, during the turn-on period of the synchronous rectification transistor M2), the inductor current I_{L} decreases.

When the magnitude of the inductor current I_{L} flowing from the switch terminal SW to the output terminal OUT decreases to zero, the polarity of the inductor current I_{L} is inverted from positive to negative by the action of the output inductor L0. The timing of this inversion is timing t_{C3} after timing t_{C2}. At timing t_{C3}, the reverse current detection circuit 18 detects the reverse current of the inductor current I_{L}, so that the reverse current detection signal ZX switches from the low level to the high level and is latched at the high level. The drive circuit 17 receives the reverse current detection signal ZX of high level and switches the output stage circuit MM from the output low state to the Hi-Z state.

On the other hand, since the output voltage V_{OUT} rises above the target voltage V_{TG} between timings t_{C1} and t_{C2}, after the timing t_{C2} and before timing t_{C11} to be described later, the established state of “V_{SLP}<V_{CMP}” is switched to the established state of “V_{SLP}>V_{CMP}” again, and the level of the comparison result signal S2 transitions to the high level again based on the establishment of “V_{SLP}>V_{CMP}.” The high level of the comparison result signal S2 continues even at timing t_{C11} to be described later.

At timing t_{C11} after the time corresponding to the PWM cycle (that is, the time corresponding to the reciprocal of the frequency f_{PWM}) has passed since timing t_{C1}, a down-edge again occurs in the clock signal S1. The logic circuit 16 does not generate an up-edge in the control signal S3 even if the down-edge occurs in the clock signal S1 when the comparison result signal S2 is at the high level. This corresponds to the skip control. In the example of FIG. 10, since the comparison result signal S2 is at the high level at timing t_{C11}, the logic circuit 16 invalidates the down-edge of the clock signal S1 at timing t_{C11} and maintains the control signal S3 at the low level after timing t_{C11}.

At timing t_{C21} after the time corresponding to the PWM cycle (that is, the time corresponding to the reciprocal of the frequency f_{PWM}) has passed since timing t_{C11}, a down-edge again occurs in the clock signal S1. In conjunction with the decrease in the output voltage V_{OUT} from timing t_{C2} to timing t_{C21}, after timing t_{C11} and before timing t_{C21}, it is assumed that the established state of “V_{SLP}>V_{CMP}” transitions to the established state of “V_{SLP}<V_{CMP}” and the comparison result signal S2 is at the low level at timing t_{C21}. Therefore, the logic circuit 16 generates an up-edge in the control signal S3 in response to the down-edge of the clock signal S1 at timing t_{C21}. The up-edge of the control signal S3 at timing t_{C21} or the up-edge of the gate signal G1 based thereon releases the latch of the level of the reverse current detection signal ZX which is at the high level, and the level of the reverse current detection signal ZX transitions to the low level. The output stage circuit MM switches from the Hi-Z state to the output high state in synchronization with the up-edge of the control signal S3 at timing t_{C21}. If the output current I_{OUT} remains unchanged, the operation from timing t_{C1} to immediately before timing t_{C21} is repeatedly performed after timing t_{C21}.

In the example of FIG. 10, the skip control is performed in the operation from timing t_{C1} to immediately before timing t_{C21}. The skip control is a control where, after setting the state of the output stage circuit MM to the Hi-Z state by detection of the reverse current of the inductor current I_{L}, the output stage circuit MM is maintained in the Hi-Z state regardless of the clock signal S1 during a period in which the comparison result signal S2 is at the high level, that is, during a period in which the voltage V1 (the error voltage V_{CMP}) is lower than the voltage V2 (the slope voltage V_{SLP}).

In the skip control, a pulse in the clock signal S1 is skipped. The skip of the pulse refers to invalidating the down-edge of the clock signal S1 and maintaining the control signal S3 at a low level. Although the number of skips of the pulse is 1 in the example of FIG. 10, the number of the skips of the pulse can take any value of 1 or more according to the output current I_{OUT}.

In a period during which the skip control is continuously performed, if the length of the high level period per one time in the control signal S3 is constant, the power supply IC 2 performs a PFM control. The PFM is an abbreviation for Pulse Frequency Modulation. Since the length of the high level period per one time in the control signal S3 can vary during the period in which the skip control is continuously performed, a switching control accompanying the skip control can also be referred to as a pseudo PFM control.

### First Virtual Operation

A first virtual operation will now be described. The first virtual operation and second and third virtual operations to be described later are virtual operations used for comparison with the operation of the switching power supply device 1 according to the present embodiment. Although these virtual operations are different from the operation actually executed in the switching power supply device 1, each virtual operation will be described with reference to the above-described reference numerals and the like for the sake of the specificity of the description.

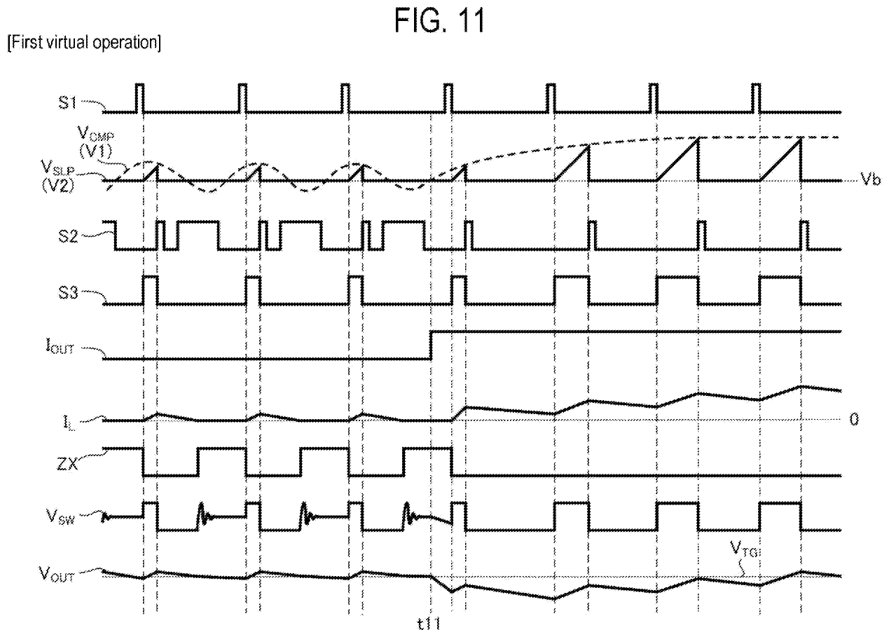

FIG. 11 is a timing chart related to the first virtual operation. FIG. 11 shows various signal waveforms in the switching power supply device 1 in the first virtual operation. In the example of FIG. 11, the output current I_{OUT} is relatively small until timing t11, and the output current I_{OUT} sharply increases after timing t11. In the example of FIG. 11, in each switching cycle up to timing t11, the reverse current detection signal ZX of a high level, which is accompanied with the detection of the reverse current of the inductor current I_{L}, appears. In the first virtual operation, the slope voltage V_{SLP} is maintained at a predetermined reset level in the output low state and Hi-Z state of the output stage circuit MM. In the first virtual operation and the second virtual operation to be described later, the reset level corresponds to the level of a bias voltage Vb. At the time of a light load, even if the output transistor M1 is turned off, the output voltage V_{OUT} does not easily fall below the target voltage V_{TG}. Therefore, in the first virtual operation, the error voltage V_{CMP} fluctuates at a very low voltage level (near the reset level).

As a result of the reverse current detection in the switching cycle including timing t11, both of the transistors M1 and M2 are turned off at timing t11. Therefore, after timing t11, the output voltage V_{OUT} decreases due to the relatively large output current I_{OUT} until the next switching cycle returns. Further, the error voltage V_{CMP} increases as the output voltage V_{OUT} decreases. In a switching cycle immediately after timing t11, the output transistor M1 is turned on in synchronization with the down-edge of the clock signal S1, but the error voltage V_{CMP} at this stage is close to the previous reset level. Therefore, the slope voltage V_{SLP} reaches the error voltage V_{CMP} in a short time. In other words, since the turn-on period of the output transistor M1 becomes shorter than the ideal turn-on period thereof, the output voltage V_{OUT} cannot be raised sufficiently. Thereafter, in each switching cycle in a process during which the error voltage V_{CMP} increases, although the turn-on period of the output transistor M1 increases to approach the ideal turn-on period thereof, the increment of the output voltage V_{OUT} becomes insufficient in this process.

As described above, in the first virtual operation, since the error voltage V_{CMP} drops to near the reset level of the slope voltage V_{SLP} at the time of a light load, the responsiveness (load responsiveness) deteriorates when the output current I_{OUT} sharply increases.

### Second Virtual Operation

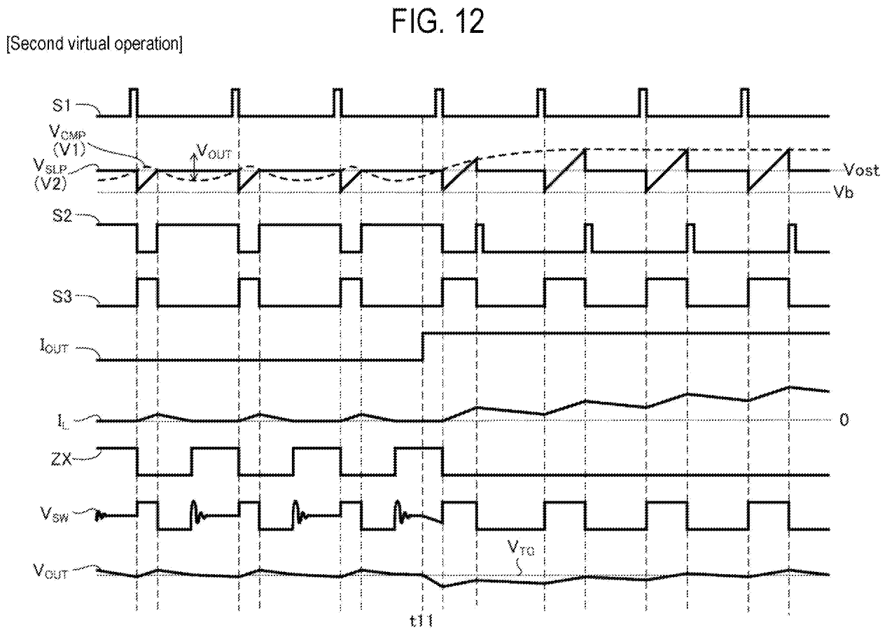

In consideration of this, it has been studied to set an offset voltage corresponding to the output voltage V_{OUT} to the slope voltage V_{SLP} during all or a part of the turn-off period of the output transistor M1 (for example, during the high level period of the reverse current detection signal ZX). The second virtual operation is obtained by adding an offset voltage setting operation to the first virtual operation. FIG. 12 is a timing chart related to the second virtual operation. In the second virtual operation of FIG. 12, the slope voltage V_{SLP} is raised from the reset level Vb with a slope corresponding to the input voltage V_{IN} in response to the down-edge of the clock signal S1 in each switching cycle, and after the slope voltage V_{SLP} reaches the error voltage V_{CMP}, the slope voltage V_{SLP} is set and maintained at an offset voltage Vost corresponding to the output voltage V_{OUT}.

When the offset voltage Vost is properly set, the slope voltage V_{SLP} does not drop to the vicinity of the reset level even at the time of a light load, and it is possible to intentionally raise the error voltage V_{CMP}. As a result, the error voltage V_{CMP} can be brought to an ideal level or a level approximating the ideal level immediately after timing t11 at which the output current I_{OUT} sharply increases, and it is possible to sufficiently gain the turn-on period of the output transistor M1 from the switching cycle immediately after timing t11. Therefore, an improvement in load responsiveness can be expected.

Here, if the offset voltage Vost is too high, the operation after timing t11 may become unstable. For example, if the offset voltage Vost becomes too high, the length of the high level period of the control signal S3 (hereinafter referred to as the pulse width of the control signal S3) in the switching cycle immediately after timing t11 becomes too much larger than the ideal width, which may lead to an overshoot of the output voltage V_{OUT}. Considering this, in the second virtual operation, the offset voltage Vost is set to be lower than the level of the error voltage V_{CMP} in the PWM control which does not accompany the reverse current blocking operation (the PWM control after time t11 in FIG. 12).

Then, in FIG. 12, as can be understood from the comparison between the control signal S3 before timing t11 and the control signal S3 after timing t11, the pulse width of the control signal S3 is shorter during the period in which the reverse current blocking operation is performed (before timing t11) than otherwise (after timing t11). FIG. 12 does not show how the skip control is performed before timing t11, but the same is true when the skip control is performed before timing t11. When the second virtual operation is used, it is difficult to lengthen the turn-on time of the output transistor M1 in a light load condition with the skip control.

### Third Virtual Operation

On the other hand, in order to improve efficiency in the light load condition which accompanies the skip control (efficiency in the pseudo PFM control), it is effective to lengthen the time during which the pulse of the clock signal Si is skipped (hereinafter referred to as skip time). A burst mode is used in the third virtual operation. In the burst mode, in the light load condition accompanying the skip control, successive pulses are generated for one down-edge of the clock signal S1 and are included in the control signal S3, and the output transistor M1 is turned on during each pulse period in the successive pulses.

By using the burst mode, the output voltage V_{OUT} rises greatly with respect to one down-edge of the clock signal S1, and the output voltage V_{OUT} can be kept above the target voltage V_{TG} for a relatively long time. Therefore, it is possible to lengthen the skip time.

However, in the burst mode, it is necessary to charge/discharge the gates of the transistors M1 and M2 whenever the transistors M1 and M2 are turned on/off by the successive pulses. Therefore, there is no or little effect of reducing a switching loss.

### Goals and Suggestions

In the light load condition with the skip control, if the pulse width of the control signal S3 can be increased, that is, if the turn-on period of one time for the output transistor M1 can be lengthened, the skip time can be lengthened. By increasing the skip time, it is possible to reduce the switching loss in the light load condition, and as a result, an improvement in efficiency of the switching power supply device 1 can be expected. For example, under the assumption that the output current I_{OUT} is constant in the light load condition accompanying the skip control, if the pulse width of the control signal S3 can be doubled, since an amount of energy transferred to the output terminal OUT for the turn-on period of one time for the output transistor M1 is quadrupled, the skip time is quadrupled. As a result, the switching loss in the light load condition can be reduced as much as ¼.

In the switching power supply device 1 according to the present embodiment, the configuration of the slope voltage generation circuit 13 is devised to reduce the switching loss in the light load condition.

Hereinafter, among a plurality of Examples, some specific configuration examples, application techniques, modification techniques, and the like related to the switching power supply device 1 (particularly the slope voltage generation circuit 13) will be described. The matters described above in the present embodiment are applied to each of the following Examples unless otherwise stated or inconsistent (except for the first to third virtual operations). In each Example, if there are matters that contradict the above-described matters, the description in each Example may take precedence. In addition, as long as there is no contradiction, the matters described in any of the following Examples can be applied to any other Examples (that is, it is also possible to combine any two or more of the Examples).

### FIRST EXAMPLE

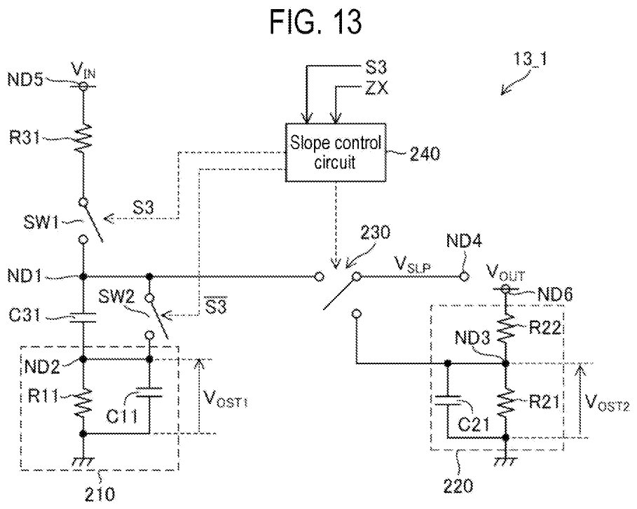

A first Example will be described. FIG. 13 shows a circuit diagram of a slope voltage generation circuit 13_1 according to the first Example. In the first Example, the slope voltage generation circuit 13_1 is used as the slope voltage generation circuit 13 of FIG. 1.

The slope voltage generation circuit 13_1 of FIG. 13 includes resistors R11, R21, R22, and R31, capacitors C11, C21, and C31, switches SW1 and SW2, a switching circuit 230, and a slope control circuit 240. The resistor R11 and the capacitor C11 are a first offset resistor and a first offset capacitor, respectively. A first offset voltage generation circuit 210 is configured by the resistor R11 and the capacitor C11. A voltage generated across the capacitor C11 is a first offset voltage V_{OST1} (V_{OST1}≥0). The resistor R21 is a second offset resistor. A second offset voltage generation circuit 220 is configured by the resistors R21 and R22 and the capacitor C21. A voltage generated across the resistor R21 is a second offset voltage V_{OST2} (V_{OST2}>0). It is desirable that the slope voltage generation circuit 13_1 is configured so that “V_{OST2}>V_{OST1}” is always established. The capacitor C31 is a slope capacitor.

The connection relationship between circuit elements in FIG. 13 will be described. One end of the resistor R31 is connected to a node ND5 to which the input voltage V_{IN} is applied, and the other end of the resistor R31 is connected to one end of the switch SW1. The other end of switch SW1 is connected to a node ND1. One end of the capacitor C31 is connected to the node ND1, and the other end of the capacitor C31 is connected to a node ND2. The switch SW2 is connected in parallel with the capacitor C31. Accordingly, one end of the switch SW2 is connected to the node ND1, and the other end of the switch SW2 is connected to the node ND2. One end of the capacitor C11 is connected to the node ND2, and the other end of the capacitor C11 is connected to the ground. The resistor R11 is connected in parallel with the capacitor C11. Accordingly, one end of the resistor R11 is connected to the node ND2, and the other end of the resistor R11 is connected to the ground. The first offset voltage V_{OST1} is applied to the node ND2.

One end of the resistor R22 is connected to a node ND6 to which the output voltage V_{OUT} is applied, and the other end of the resistor R22 is connected to a node ND3. One end of the resistor R21 is connected to the node ND3, and the other end of the resistor R21 is connected to the ground. The capacitor C21 is connected in parallel with the resistor R21. Accordingly, one end of the capacitor C21 is connected to the node ND3, and the other end of the capacitor C21 is connected to the ground. The second offset voltage V_{OST2} is applied to the node ND3. That is, in the second offset voltage generation circuit 220, a current corresponding to the output voltage V_{OUT} is supplied to the resistor R21 to generate the second offset voltage V_{OST2} across the resistor R21.

The switching circuit 230 is connected to the nodes ND1, ND3, and ND4 and connects one of the nodes ND1 and ND3 to a node ND4. A voltage at the node ND4 is a slope voltage V_{SLP}. That is, the switching circuit 230 switches a voltage at the node ND1 or a voltage at the node ND3 (therefore, the second offset voltage V_{OST2}) to the slope voltage V_{SLP} and outputs the slope voltage V_{SLP}. The switching circuit 230 can also be called a selector.

Based on the control signal S3 and the reverse current detection signal ZX, the slope control circuit 240 controls on/off of the switches SW1 and SW2 and controls the state of the switching circuit 230. As described above, the high level period of the control signal S3 corresponds to the period in which the output stage circuit MM is in the output high state (the turn-on period of the output transistor M1), and the low level period of the control signal S3 corresponds to the period in which the output stage circuit MM is in the output low state or the Hi-Z state (the turn-off period of the output transistor M1).

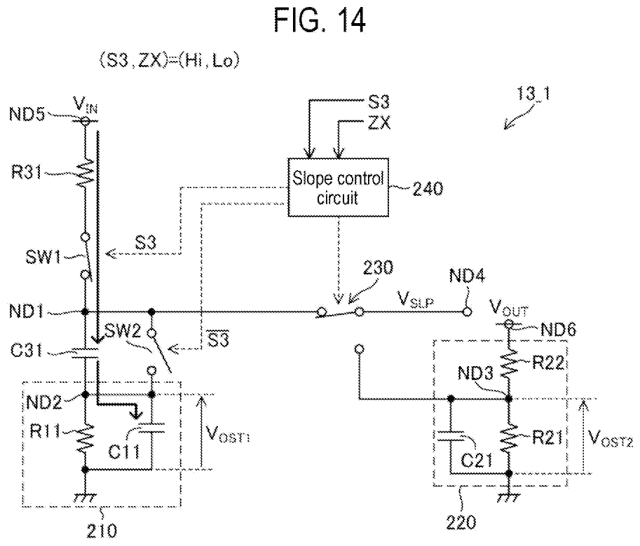

As shown in FIG. 14, the slope control circuit 240 turns on the switch SW1 and turns off the switch SW2 during the high level period of the control signal S3, and causes the switching circuit 230 to connect the node ND1 to the node ND4. Therefore, during the high level period of the control signal S3, the voltage of the node ND1 is generated and output as the slope voltage V_{SLP}. Further, the reverse current detection signal ZX is always at a low level during the high level period of the control signal S3.

During the high level period of the control signal S3 (the turn-on period of the output transistor M1), the switch SW1 is turned on and the switch SW2 is turned off, so that a current (slope current) corresponding to the input voltage V_{IN} is supplied from the node ND5 to the node ND1, and as a result, the capacitors C31 and C11 are charged. More specifically, during the high level period of the control signal S3, a current (slope current) corresponding to the input voltage V_{IN} flows from the node ND5 toward the node ND1, as a charging current for the capacitor C31, and the potential of the node ND1 rises, and at the same time, the charging current also flows to the capacitor C11 through the capacitor C31, so that the potential of the node ND2 (that is, the first offset voltage V_{OST1}) also rises.

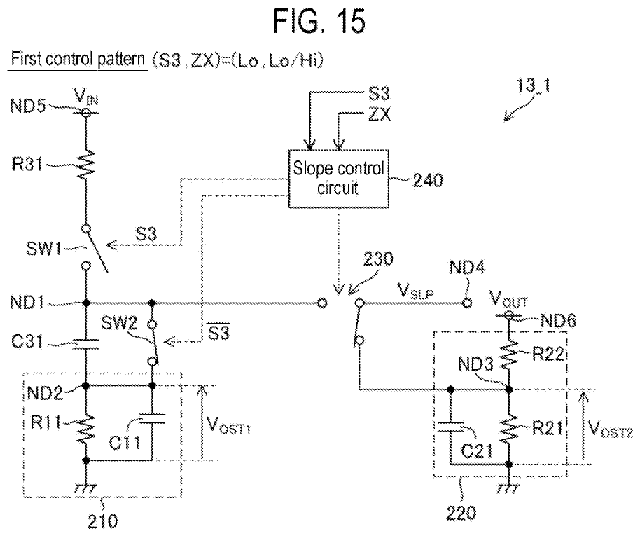

During the low level period of the control signal S3, the slope control circuit 240 may control the states of the switches SW1 and SW2 and the switching circuit 230 according to the following first control pattern. FIG. 15 corresponds to the first control pattern.

As shown in FIG. 15, the slope control circuit 240 according to the first control pattern turns off the switch SW1 and turns on the switch SW2 irrespective of the level of the reverse current detection signal ZX during the low level period of the control signal S3, and causes the switching circuit 230 to connect the node ND3 to the node ND4. Therefore, during the low level period of the control signal S3 in the first control pattern, the voltage of the node ND3 (that is, the second offset voltage V_{OST2}) is generated and output as the slope voltage V_{SLP} irrespective of the level of the reverse current detection signal ZX. In addition, the switch SW1 is turned off to cut off the supply of the current (slope current) from the node ND5 to the node ND1. The switch SW2 is turned on to discharge the charges stored in the capacitor C31.

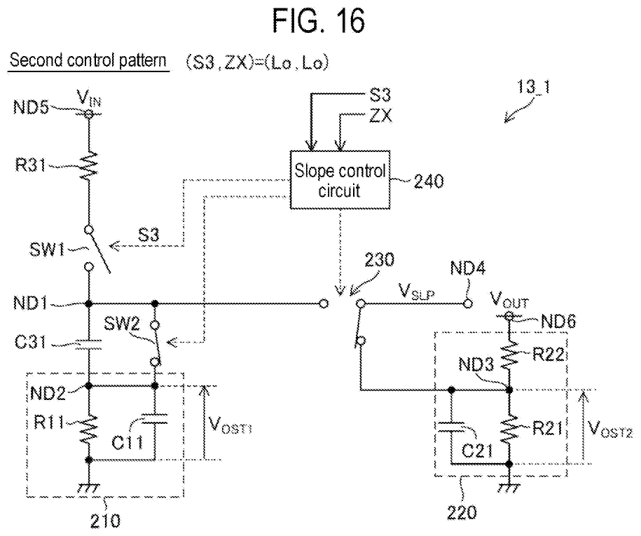

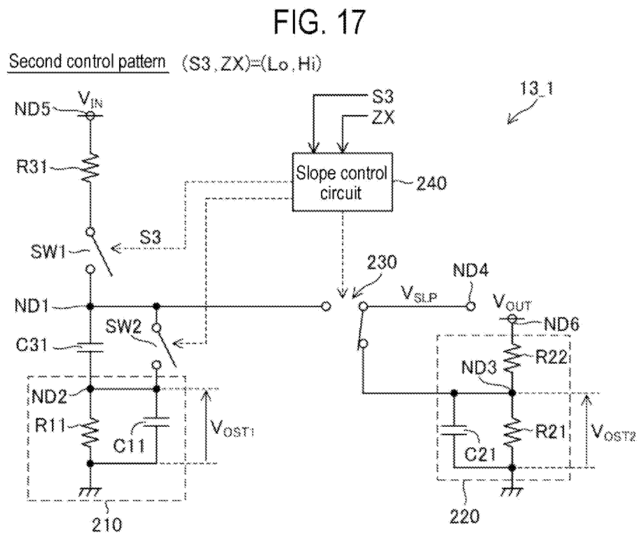

Alternatively, during the low level period of the control signal S3, the slope control circuit 240 may control the states of the switches SW1 and SW2 and the switching circuit 230 according to the following second control pattern. FIGS. 16 and 17 correspond to the second control pattern.

The slope control circuit 240 according to the second control pattern turns off the switch SW1, turns on the switch SW2, and causes the switching circuit 230 to connect the node ND3 to the node ND4 when the reverse current detection signal ZX is at a low level as shown in FIG. 16 during the low level period of the control signal S3. The slope control circuit 240 according to the second control pattern turns off both of the switches SW1 and SW2 and causes the switching circuit 230 to connect the node ND3 to the node ND4 when the reverse current detection signal ZX is at a high level as shown in FIG. 17 during the low level period of the control signal S3. Therefore, during the low level period of the control signal S3 in the second control pattern, the voltage of the node ND3 (that is, the second offset voltage V_{OST2}) is generated and output as the slope voltage V_{SLP} irrespective of the level of the reverse current detection signal ZX. In addition, the switch SW1 is turned off to cut off the supply of the current (slope current) from the node ND5 to the node ND1. During the turn-on period of the switch SW2, the charges stored in the capacitor C31 are discharged.

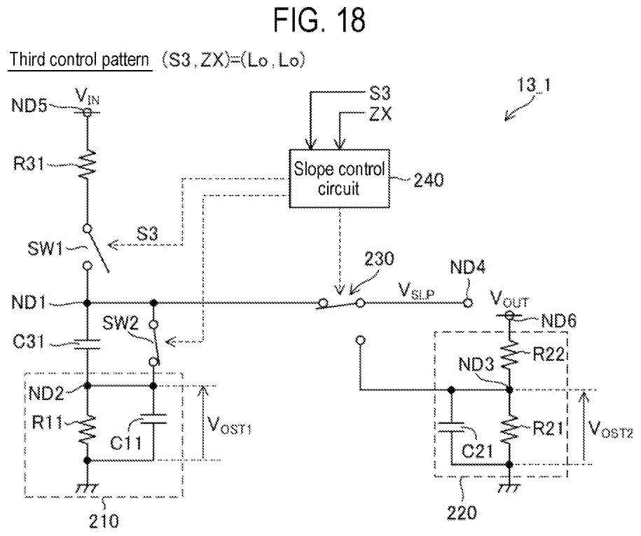

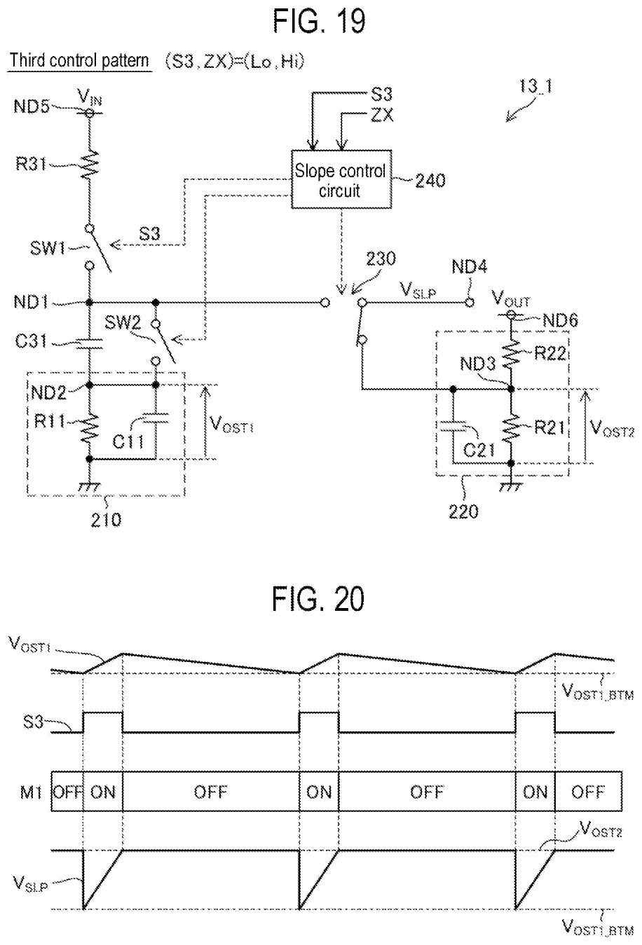

Alternatively, during the low level period of the control signal S3, the slope control circuit 240 may control the states of the switches SW1 and SW2 and the switching circuit 230 according to the following third control pattern. FIGS. 18 and 19 correspond to the third control pattern.

The slope control circuit 240 according to the third control pattern turns off the switch SW1, turns on the switch SW2, and causes the switching circuit 230 to connect the node ND1 to the node ND4 when the reverse current detection signal ZX is at a low level as shown in FIG. 18 during the low level period of the control signal S3. The slope control circuit 240 according to the third control pattern turns off both of the switches SW1 and SW2 and causes the switching circuit 230 to connect the node ND3 to the node ND4 when the reverse current detection signal ZX is at a high level as shown in FIG. 19 during the low level period of the control signal S3. Therefore, during the low level period of the control signal S3 in the third control pattern, the voltage of the node ND1 is generated and output as the slope voltage V_{SLP} when the reverse current detection signal ZX is at the low level, and the voltage of the node ND3 (that is, the second offset voltage V_{OST2}) is generated and output as the slope voltage V_{SLP} when the reverse current detection signal ZX is at the high level. In addition, the switch SW1 is turned off to cut off the supply of the current (slope current) from the node ND5 to the node ND1. During the turn-on period of the switch SW2, the charges stored in the capacitor C31 are discharged. In the third control pattern, when both the control signal S3 and the reverse current detection signal ZX are at a low level, the voltage of the node ND1 is equal to the first offset voltage V_{OST1}.

In the third control pattern, if the control signal S3 is at a low level, the switch SW2 may be kept on irrespective of the level of the reverse current detection signal ZX.

Any one of the first to third control patterns may be used fixedly during the low level period of the control signal S3. Alternatively, the third control pattern may be used during the period in which the PWM control (the first or second PWM control) is performed, and the first or second control pattern may be used during the period in which the skip control is performed.

Regardless of which of the first to third control patterns is used, the switch SW2 is turned on during at least a part of the turn-off period of the output transistor M1 to discharge the charges stored in the capacitor C31.

FIG. 20 shows a waveform example of the first offset voltage V_{OST1}. During the high level period of the control signal S3 (that is, the turn-on period of the output transistor M1), a current corresponding to the input voltage V_{IN} from the node ND5 is supplied to the capacitor C11 through the capacitor C31 by turning on the switch SW1 (see FIG. 14). As a result, the first offset voltage V_{OST1} rises. Then, regardless of which of the first to third control patterns is used, the switch SW1 is turned off during the low level period of the control signal S3 (that is, the turn-off period of the output transistor M1), so that the supply of the charging current to the capacitor C11 through the switch SW1 is stopped, while the charges stored in the capacitor C11 are discharged through the resistor R11, and as a result, the first offset voltage V_{OST1} decreases. If the output current I_{OUT} is constant, the minimum value of the first offset voltage V_{OST1} is maintained at a constant level. This minimum value is called a bottom value V_{OST1_BTM}.

As is clear from the above description, the first offset voltage V_{OST1} is a voltage corresponding to the ratio between the turn-on period of the output transistor M1 and the turn-off period of the output transistor M1. The ratio of the turn-on period of the output transistor M1 to the turn-off period of the output transistor M1 is represented by a symbol “RT_{ON}.” The first offset voltage V_{OST1} and the bottom value V_{OST1_BTM} increase as the ratio RT_{ON} increases, and decrease as the ratio RT_{ON} decreases. However, the first offset voltage V_{OST1} and the bottom value V_{OST1_BTM} have a lower limit, and the lower limit is 0 V (volts) here.

FIG. 20 also shows a waveform of the slope voltage V_{SLP}. The waveform of the slope voltage V_{SLP} in FIG. 20 is a waveform when the first or second control pattern is used. No matter which one of the first to third control patterns is used, the voltage of the node ND1 is equal to the first offset voltage V_{OST1} because no charges are stored in the capacitor C31 immediately before the up-edge occurs in the control signal S3. Then, by setting the states of the switches SW1 and SW2 and the switching circuit 230 to the states shown in FIG. 14 in response to the up-edge of the control signal S3, the slope voltage V_{SLP} rises from the first offset voltage V_{OST1} (specifically, the bottom value V_{OST1_BTM}) with a slope corresponding to the input voltage V_{IN}. That is, the slope voltage generation circuit 13_1 increases the slope voltage V_{SLP} from the first offset voltage V_{OST1} (specifically, the bottom value V_{OST1_BTM}) with the slope corresponding to the input voltage V_{IN} during the turn-on period of the output transistor M1 (the same applies to slope voltage generation circuits according to other Examples to be described later).

After that, when a down-edge occurs in the control signal S3, the switching circuit 230 connects the node ND4 to the node ND3 (see FIG. 15 or 16), so that the slope voltage V_{SLP} is set to the second offset voltage V_{OST2}, as shown in FIG. 20, and is maintained at the second offset voltage V_{OST2} until the next up-edge occurs in the control signal S3.

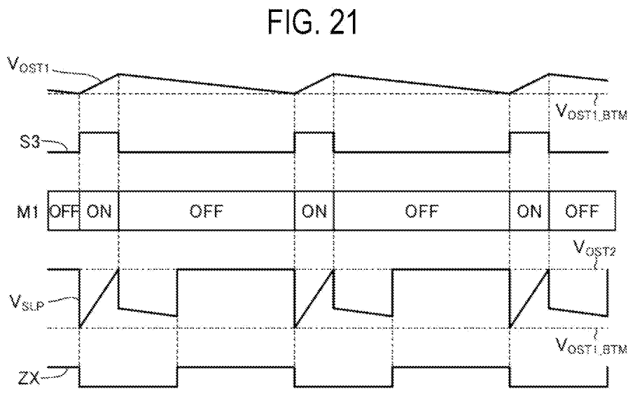

As described above, FIG. 20 assumes the use of the first or second control pattern. If the third control pattern is used (see FIGS. 18 and 19), since the switch SW2 is turned on in response to the down-edge of the control signal S3 while maintaining conduction between the nodes ND1 and ND4, the slope voltage V_{SLP} steeply drops to the first offset voltage V_{OST1}, as shown in FIG. 21, and thereafter, the slope voltage V_{SLP} is set to the second offset voltage V_{OST2} in response to the up-edge of the reverse current detection signal ZX (the light load condition in which the reverse current blocking operation is performed is assumed in FIG. 21). Thereafter, the slope voltage V_{SLP} is maintained at the second offset voltage V_{OST2} until the next up-edge occurs in the control signal S3.

In this way, the slope voltage generation circuit 13_1 sets the slope voltage V_{SLP} to the second offset voltage V_{OST2} during at least a part of the turn-off period of the output transistor M1 (the same applies to the slope voltage generation circuits according to other Examples to be described later).

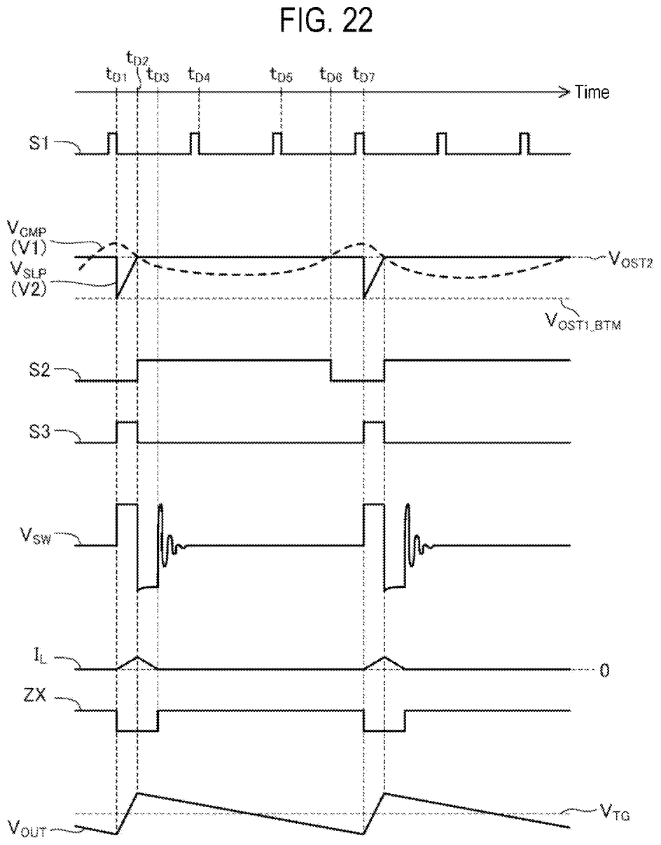

FIG. 22 is a timing chart for explaining the operation according to the first Example, and various signal waveforms when the skip control is performed are shown. Assume that timings t_{D1}, t_{D2}, t_{D3}, t_{D4}, t_{D5}, t_{D6}, and t_{D7} are visited in this order as time passes.

In the example of FIG. 22, a down-edge occurs in the clock signal S1 at timing t_{D1}, and an up-edge occurs in the control signal S3 in response to the down-edge of the clock signal S1. It is assumed that “V_{SLP}<V_{CMP}” at timing t_{D1}. It is also assumed that the reverse current detection signal ZX is latched to a high level immediately before timing t_{D1} and the state of the output stage circuit MM is the Hi-Z state. The up-edge of the control signal S3 at the timing t_{D1} or the up-edge of the gate signal G1 based thereon releases the latch of the level of the reverse current detection signal ZX which is at the high level, and the level of the reverse current detection signal ZX transitions to the low level. Further, the output stage circuit MM switches from the Hi-Z state to the output high state based on the up-edge of the control signal S3. During the period in which the output stage circuit MM is maintained in the output high state (that is, during the turn-on period of the output transistor M1), the inductor current I_{L} increases. In the example of FIG. 22 in which the skip control is performed, the inductor current I_{L} increases from zero during the period in which the output stage circuit MM is maintained in the output high state.

On the other hand, the slope voltage generation circuit 13_1 monotonically increases the slope voltage V_{SLP} from the first offset voltage V_{OST1} (specifically, the bottom value V_{OST1_BTM}) with a slope corresponding to the input voltage V_{IN}, starting at timing t_{D1}. As a result, the slope voltage V_{SLP} reaches the error voltage V_{CMP} at timing t_{D2} after timing t_{D1}. Specifically, at timing t_{D2}, the established state of “V_{SLP}<V_{CMP}” is switched to the established state of “V_{SLP}>V_{CMP}.” An up-edge occurs in the comparison result signal S2 in synchronization with this switching.

A down-edge occurs in the control signal S3 in response to the up-edge of the comparison result signal S2 at timing t_{D2}, thereby switching the output stage circuit MM from the output high state to the output low state. FIG. 22 assumes the use of the first or second control pattern (FIGS. 15 to 17). Therefore, by switching the connection destination of the node ND4 from the node ND1 to the node ND3 at timing t_{D2}, the second offset voltage V_{OST2} is set with respect to the slope voltage V_{SLP}. The slope voltage V_{SLP} is maintained at the second offset voltage V_{OST2} until timing t_{D7} at which the next up-edge occurs in the control signal S3.

After timing t_{D2}, the inductor current I_{L} decreases during the period in which the output stage circuit MM is maintained in the output low state (that is, during the turn-on period of the synchronous rectification transistor M2). When the magnitude of the inductor current I_{L} drops to zero, the polarity of the inductor current I_{L} is inverted from positive to negative by the action of the output inductor L0. The timing of this inversion is timing t_{D3} after timing t_{D2}. At timing tD3, the reverse current detection circuit 18 detects the reverse current of the inductor current I_{L}, so that the reverse current detection signal ZX switches from the low level to the high level and is latched at the high level. The drive circuit 17 receives the reverse current detection signal ZX of a high level and switches the output stage circuit MM from the output low state to the Hi-Z state.

On the other hand, since the output voltage V_{OUT} rises above the target voltage V_{TG} between timings t_{D1} and t_{D2}, a temporary value “V_{SLP}>V_{CMP}” is established after timing t_{D2}. After timing t_{D2}, the error voltage V_{CMP} turns to rise at some timing as the output voltage V_{OUT} decreases. In the example of FIG. 22, the established state of “V_{SLP}>V_{CMP}” is switched to the established state of “V_{SLP}<V_{CMP}” at timing t_{D6}. Therefore, in the example of FIG. 22, the comparison result signal S2 is at the high level from timing t_{D2} to immediately before timing t_{D6}, and transitions to the low level at timing t_{D6}.

Timings t_{D4}, t_{D5}, and t_{D7} are a timing at which the time corresponding to one PWM cycle has elapsed from timing t_{D1}, a timing at which the time corresponding to two PWM cycles has elapsed from timing t_{D1}, and a timing at which the time corresponding to three PWM cycles has elapsed from timing t_{D1}, respectively. A down-edge occurs in the clock signal S1 at each of timings t_{D4} and t_{D5}, but since the comparison result signal S2 is at the high level at timings t_{D4} and t_{D5} (because of “V_{SLP}>V_{CMP}”), these down-edges are invalidated by the skip control.

At timing t_{D7} after timing t_{D6}, since the comparison result signal S2 is at the low level (because of “V_{SLP}<V_{CMP}”), the logic circuit 16 generates an up-edge in the control signal S3 in response to the down-edge of the clock signal S1 at timing t_{D7}. The up-edge of the control signal S3 at timing t_{D7} or the up-edge of the gate signal G1 based thereon releases the latch of the level of the reverse current detection signal ZX which is at the high level, and the level of the reverse current detection signal ZX transitions to the low level. As a result, at timing t_{D7}, the output stage circuit MM switches from the Hi-Z state to the output high state. If the output current I_{OUT} remains unchanged, the operation from timing t_{D1} to immediately before timing t_{D7} is repeatedly performed after timing t_{D7}.

In the example of FIG. 22, if the third control pattern (see FIGS. 18 and 19) is used, although not shown specifically, the slope voltage V_{SLP} is set to the first offset voltage V_{OST1} between timings t_{D2} and t_{D3}.

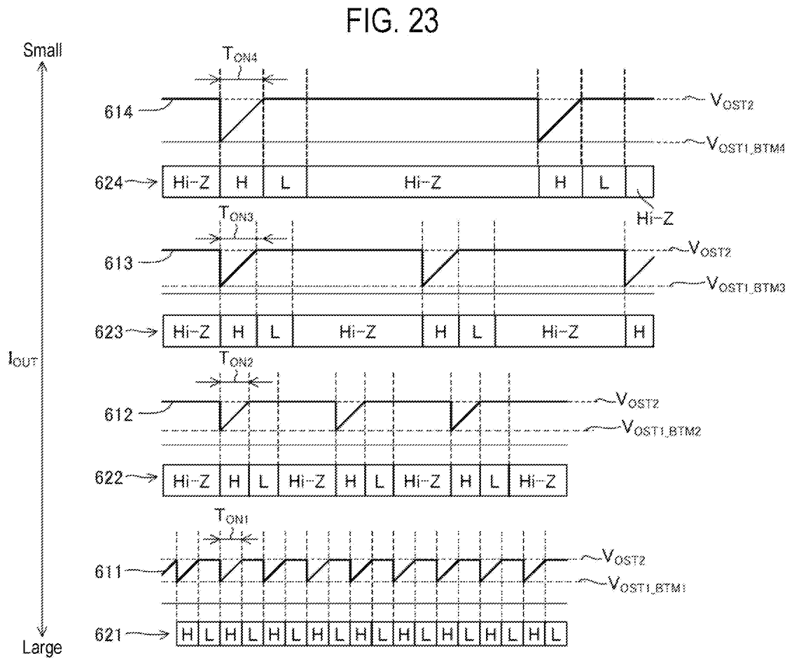

FIG. 23 shows waveforms 611 to 614 of the slope voltage V_{SLP} in first to fourth load conditions. In FIG. 23, it is assumed that the first or second control pattern (FIGS. 15 to 17) is used. Among the first to fourth load conditions, the first load condition is a condition in which the output current I_{OUT} is the largest, and in the first load condition, the inductor current I_{L} is supplied in the continuous current mode. The switching frequency of the output transistor M1 in the first load condition is the frequency f_{PWM}. The second to fourth load conditions correspond to the light load condition, and the skip control is executed in each of the second to fourth load conditions. Therefore, the switching frequency of the output transistor M1 in the second to fourth load conditions is lower than the frequency f_{PWM}. The output current I_{OUT} in the third load condition is smaller than the output current I_{OUT} in the second load condition, and the output current I_{OUT} in the fourth load condition is even smaller than the output current I_{OUT} in the third load condition. Therefore, the switching frequency of the output transistor M1 decreases in the order of the second, third, and fourth load conditions. In other words, the number of skips of the pulse of the clock signal S1 by the skip control increases in the order of the second, third, and fourth load conditions.

In FIG. 23, tables 621 to 624 represent the states of the output stage circuit MM in the first to fourth load conditions, respectively. In the tables 621 to 624, “H” means that the output stage circuit MM is in the output high state, “L” means that the output stage circuit MM is in the output low state, and “Hi-Z” means that the output stage circuit MM is in the Hi-Z state.

The bottom values V_{OST1_BTM} in the first to fourth load conditions are bottom values V_{OST1_BTM1} to V_{OST1_BTM4}, respectively. Since the ratio RT_{ON} of the turn-on period of the output transistor M1 to the turn-off period of the output transistor M1 is highest in the first load condition and decreases in the order of the first, second, third, and fourth load conditions, “V_{OST1_BTM1}>V_{OST1_BTM2}>V_{OST1_BTM3}>V_{OST1_BTM4}” is established. In the example of FIG. 23, the bottom value V_{OST1_BTM4} in the fourth load condition is zero or substantially zero. The bottom value V_{OST1_BTM} in each load condition depends on the input voltage V_{IN} and the duty of the control signal S3. When the PWM control is performed, the duty of the control signal S3 corresponds to the duty in pulse width modulation, and the bottom value V_{OST1_BTM1} depends on the output voltage V_{OUT}.

In the first to fourth load conditions, the slope voltage V_{SLP} is set to the common second offset voltage V_{OST2} during the turn-off period of the output transistor M1. Therefore, the error voltage V_{CMP} is maintained near the second offset voltage V_{OST2} in any of the first to fourth load conditions (the error voltage V_{CMP} is not shown in FIG. 23). In FIG. 23, times T_{ON1} to T_{ON4} respectively represent the pulse widths of the control signal S3 (that is, the turn-on time for one time of the output transistor M1) in the first to fourth load conditions. That is, the time from when the output transistor M1 is turned on to when it is turned off under the first load condition corresponds to the time T_{ON1}, and the time from when the output transistor M1 is turned on to when it is turned off under the second load condition corresponds to the time T_{ON2}. The same is true for the third and fourth load conditions.

In the first to fourth load conditions, since the second offset voltage V_{OST2} is common and “V_{OST1_BTM1}>V_{OST1_BTM2}>V_{OST1_BTM3}>V_{OST1_BTM4}” is established, “T_{ON1}<T_{ON2}<T_{ON3}<T_{ON4}” is established. That is, the lighter the load (the smaller the output current I_{OUT}), the greater the pulse width of the control signal S3. This means that the pulse width of the control signal S3 increases as the switching frequency decreases in the PFM control at the time of the light load.

For example, the bottom value V_{OST1_BTM} can be adjusted by adjusting the value of the resistor R11 in the configuration shown in FIG. 13. At this time, for example, if the value of the resistor R11 is adjusted so that the magnitude of the bottom value V_{OST1_BTM1} in the waveform 611 is approximately equal to the amplitude of the slope voltage V_{SLP}, the time T_{ON4} can be made twice the time T_{ON1}.

According to this Example, good load responsiveness can be ensured by setting the second offset voltage V_{OST2} to the slope voltage V_{SLP} during the turn-off period of the output transistor M1. In addition, in the light load condition where the skip control is performed, the lighter the load, the longer the skip time (therefore, the lower the switching frequency in the PFM control), thereby reducing the switching loss.

### SECOND EXAMPLE

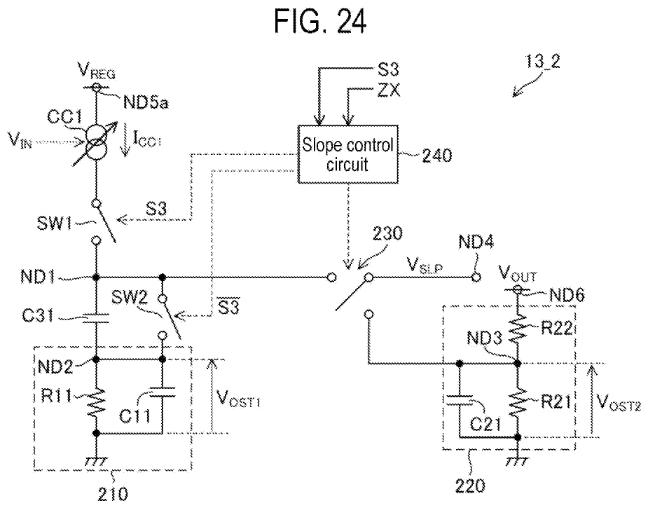

A second Example will be described. In the configuration of FIG. 13, the circuit that supplies the current corresponding to the input voltage V_{IN} toward the node ND1 can be arbitrarily changed. However, the magnitude of the current supplied toward the node ND1 during the turn-on period of the switch SW1 increases as the input voltage V_{IN} increases. For example, a slope voltage generation circuit 13_2 shown in FIG. 24 may be used as the slope voltage generation circuit 13 of FIG. 1.

With the slope voltage generation circuit 13_1 of FIG. 13 as a reference, the slope voltage generation circuit 13_2 of FIG. 24 is obtained by replacing the resistor R31 and the node ND5 with a variable current source CC1 and a node ND5a, respectively. Except for this replacement, the slope voltage generation circuit 13_2 has the same configuration as the slope voltage generation circuit 13_1.

The variable current source CC1 is connected to the node ND5a to which an internal power supply voltage V_{REG} is applied and one end of the switch SW1, and generates a current I_{CC1} having a current value proportional to the input voltage V_{IN} based on the internal power supply voltage V_{REG}. The internal power supply voltage V_{REG} is a positive DC voltage generated by an internal power supply circuit (not shown) within the power supply IC 2 based on the input voltage V_{IN}. The variable current source CC1 is provided between the node ND5a and the one end of the switch SW1 and supplies the current I_{CC1} from the node ND5a to the node ND1 only when the switch SW1 is turned on. Therefore, when the switch SW1 is turned on and the switch SW2 is turned off, the capacitors C31 and C11 are charged with a current corresponding to the input voltage V_{IN}.

### THIRD EXAMPLE

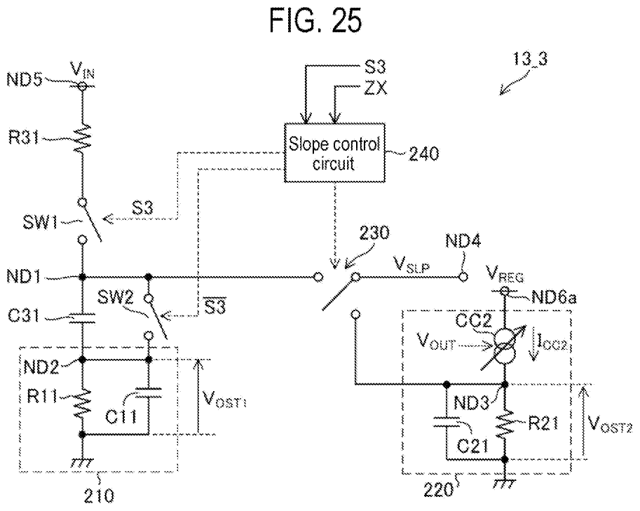

A third Example will be described. In the configuration of FIG. 13, the circuit that supplies the current corresponding to the output voltage V_{OUT} toward the node ND3 can be arbitrarily changed. However, the magnitude of the current supplied toward the node ND3 increases as the output voltage V_{OUT} increases. For example, a slope voltage generation circuit 13_3 shown in FIG. 25 may be used as the slope voltage generation circuit 13 of FIG. 1.

With the slope voltage generation circuit 13_1 of FIG. 13 as a reference, the slope voltage generation circuit 13_3 of FIG. 25 is obtained by replacing the resistor R22 and the node ND6 with a variable current source CC2 and a node ND6a, respectively. Except for this replacement, the slope voltage generation circuit 13_3 has the same configuration as the slope voltage generation circuit 13_1.

The variable current source CC2 is connected to the node ND6a to which an internal power supply voltage V_{REG} is applied and the node ND3, and generates a current I_{CC2} having a current value proportional to the output voltage V_{OUT} based on the internal power supply voltage V_{REG}. The variable current source CC2 supplies the current I_{CC2} from the node ND6a to the node ND3. Therefore, the second offset voltage V_{OST2} corresponding to the output voltage V_{OUT} is generated at the node ND3. The configuration of FIG. 24 may be combined with the configuration of FIG. 25.

### FOURTH EXAMPLE

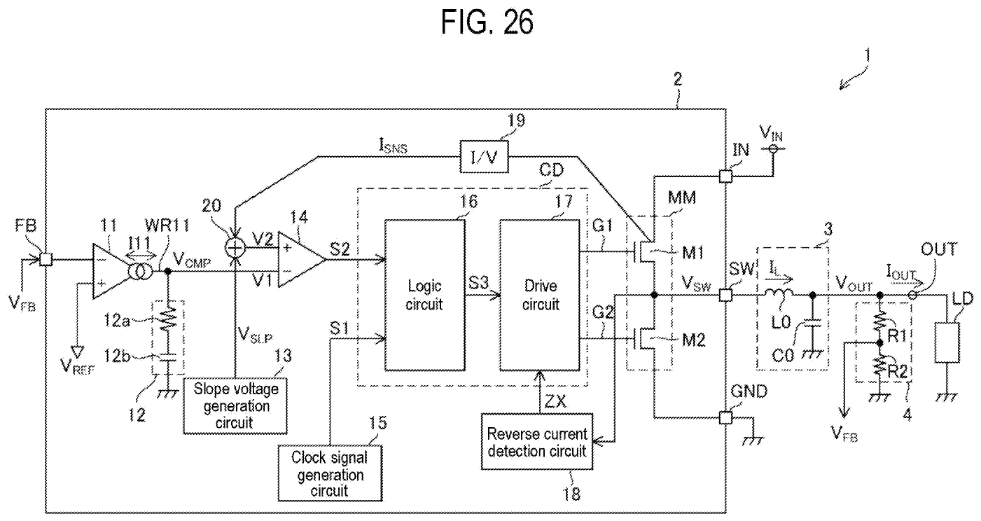

A fourth Example will be described. In the power supply IC 2, the output stage circuit MM may be switching-controlled in a current mode. In this case, as shown in FIG. 26, a current detection circuit 19 and an adder 20 may be added to the power supply IC 2 of FIG. 1, and the sum voltage of the slope voltage V_{SLP} and a voltage I_{SNS} corresponding to the inductor current I_{L} may be input as the voltage V2 to the non-inverting input terminal of the comparator 14. The current detection circuit 19 detects a current (that is, the inductor current I_{L}) flowing through the output transistor M1 during the turn-on period of the output transistor M1, and generates a voltage proportional to the detected current as the voltage I_{SNS}. The adder 20 generates the voltage V2 by adding the voltage I_{SNS} to the slope voltage V_{SLP} from the slope voltage generation circuit 13. Therefore, in the configuration of FIG. 26 according to the fourth Example, “V2=V_{SLP}+I_{SNS}” is established.

### FIFTH EXAMPLE

A fifth Example will be described. In the fifth embodiment, supplementary items or modification techniques for each configuration or each operation described above will be described.

If the output voltage V_{OUT} is within the dynamic range of the power supply IC 2, the output voltage V_{OUT} itself may be applied as the feedback voltage V_{FB} to the feedback terminal FB, and in this case, the feedback voltage generation circuit 4 is unnecessary. In any case, the feedback voltage V_{FB} is a voltage corresponding to the output voltage V_{OUT} (a voltage proportional to the output voltage V_{OUT}).

The output stage circuit MM may be provided outside the power supply IC 2 and externally connected to the power supply IC 2.

The types of channels of FETs (Field Effect Transistors) shown in each embodiment are examples. Without detracting from the spirit of the above disclosure, the type of channel of any FET may be changed between the P-channel type and the N-channel type. For example, the output transistor M1 may be composed of a P-channel MOSFET.

Although the step-down switching power supply device has been described as an example of the switching power supply device according to the present disclosure, the switching power supply device according to the present disclosure may be a step-up switching power supply device or a step-up/step-down switching power supply device.

For any signal or voltage, its high level/low level relationship may be reversed from those described above without departing from the spirit of the above disclosure. Although the configuration in which the up-edge occurs in the control signal S3 in response to the down-edge of the clock signal S1 has been exemplified, a configuration in which the up-edge occurs in the control signal S3 in response to an up-edge of the clock signal S1 may be employed.

Any of the transistors described above may be any type of transistor as long as it does not cause any inconvenience. For example, any transistor described above as a MOSFET may be replaced with a junction FET, an IGBT (Insulated Gate Bipolar Transistor), or a bipolar transistor as long as it does not cause any inconvenience. Any transistor has a first electrode, a second electrode, and a control electrode. In the FET, one of the first and second electrodes is the drain, the other is the source, and the control electrode is the gate. In the IGBT, one of the first and second electrodes is the collector, the other is the emitter, and the control electrode is the gate. In the bipolar transistor not belonging to the IGBT, one of the first and second electrodes is the collector, the other is the emitter, and the control electrode is the base.

The embodiments of the present disclosure can be appropriately modified in various ways within the scope of the technical ideas indicated in the claims. The above embodiments are merely examples of the embodiments of the present disclosure, and the meanings of the terms of the present disclosure and each constituent element are not limited to those described in the above embodiments. The specific numerical values given in the above description are merely examples and can, of course, be changed to various numerical values.

### SUPPLEMENTARY NOTES

Supplementary Notes are provided for the present disclosure in which specific configuration examples are shown in the above-described embodiments.

A switching power supply circuit (2) according to one aspect of the present disclosure includes an output stage circuit (MM) having an output transistor (M1) configured to receive an input voltage (V_{IN}) and a synchronous rectification transistor (M2) connected in series with the output transistor at a low potential side of the output transistor, and is configured to generate an output voltage (V_{OUT}) from the input voltage by supplying an inductor current (I_{L}) to an output inductor (L0) via the output transistor or the synchronous rectification transistor through turn-on/off of the output transistor and the synchronous rectification transistor. The switching power supply circuit (2) has a configuration (first configuration) that includes: an error amplifier (11) configured to generate an error voltage (V_{CMP}) corresponding to a difference between a feedback voltage (V_{FB}) corresponding to the output voltage and a predetermined reference voltage (V_{REF}); a slope voltage generation circuit (13) configured to generate a slope voltage (V_{SLP}); a comparator (14) configured to generate a comparison result signal (S2) by comparing a first comparison voltage, which is the error voltage, with a second comparison voltage which is the slope voltage or a sum of the slope voltage and a voltage corresponding to the inductor current; a clock signal generation circuit (15) configured to generate a clock signal (S1) having a predetermined frequency; a control drive circuit (CD) configured to control the output stage circuit based on the clock signal and the comparison result signal; and a reverse current detection circuit (18) configured to detect a reverse current of the inductor current, wherein the control drive circuit turns off the synchronous rectification transistor when the reverse current of the inductor current is detected while the synchronous rectification transistor is turned on, wherein the slope voltage generation circuit includes: a first offset voltage generation circuit (210) configured to generate a first offset voltage (V_{OST1}) corresponding to a ratio between a turn-on period of the output transistor and a turn-off period of the output transistor; and a second offset voltage generation circuit (220) configured to generate a second offset voltage (V_{OST2}) according to the output voltage, wherein the slope voltage is increased from the first offset voltage with a slope corresponding to the input voltage during the turn-on period of the output transistor, and wherein the slope voltage is set to the second offset voltage during at least a part of the turn-off period of the output transistor.

It is possible to improve the load responsiveness by setting the slope voltage to the second offset voltage corresponding to the output voltage during at least a part of the turn-off period of the output transistor. Further, during the turn-on period of the output transistor, the slope voltage is increased from the first offset voltage with a slope corresponding to the input voltage, and the first offset voltage is set to a voltage corresponding to the ratio between the turn-on period of the output transistor and the turn-off period of the output transistor. As a result, it is possible to increase the turn-on period of the output transistor in conjunction with the decrease in the switching frequency at the time of a light load, and it is possible to reduce the switching loss due to the decrease in the switching frequency. By reducing the switching loss, the efficiency of the switching power supply circuit and the switching power supply device (the efficiency at the time of the light load) can be improved.

The switching power supply circuit of the first configuration may have a configuration (second configuration) wherein the control drive circuit controls a state of the output stage circuit to one of an output high state in which the output transistor is turned on and the synchronous rectification transistor is turned off, an output low state in which the output transistor is turned off and the synchronous rectification transistor is turned on, and an output off state in which both the output transistor and the synchronous rectification transistor are turned off, wherein the clock signal generation circuit changes a level of the clock signal from a first level to a second level at the predetermined frequency, wherein the control drive circuit performs a basic unit operation when the level of the clock signal is changed from the first level to the second level when the first comparison voltage is higher than the second comparison voltage, wherein in the basic unit operation, the control drive circuit switches the output stage circuit from the output low state or the output off state to the output high state in response to the change in the level of the clock signal from the first level to the second level, then switches the output stage circuit from the output high state to the output low state in response to an input of the comparison result signal indicating that the second comparison voltage has reached the first comparison voltage, and thereafter switches the output stage circuit from the output low state to the output off state if the reverse current of the inductor current is detected, and wherein the control drive circuit sets the state of the output stage circuit to the output off state through the detection of the reverse current of the inductor current and then performs skip control (see FIG. 10) in which the output stage circuit is maintained in the output off state irrespective of the clock signal during a period in which the first comparison voltage is lower than the second comparison voltage.

As a result, the switching frequency changes according to the magnitude of a load at the time of the light load in which the skip control is performed. In this configuration, it is possible to increase the turn-on period of the output transistor in conjunction with the decrease in the switching frequency at the time of the light load, and it is possible to reduce the switching loss due to the decrease in the switching frequency.

The switching power supply circuit of the first or second configuration may have a configuration (third configuration) wherein the first offset voltage generation circuit decreases the first offset voltage as the ratio of the turn-on period of the output transistor to the turn-off period of the output transistor decreases.

The switching power supply circuit of any one of the first to third configurations may have a configuration (fourth configuration) wherein the error amplifier decreases the error voltage when the feedback voltage is higher than the reference voltage, and increases the error voltage when the feedback voltage is lower than the reference voltage.

The switching power supply circuit of any one of the first to fourth configurations may have a configuration (fifth configuration) wherein the first offset voltage generation circuit has a first offset capacitor and a first offset resistor connected in parallel to the first offset capacitor, wherein the first offset voltage is generated across the first offset capacitor, and wherein the slope voltage generation circuit charges the first offset capacitor with a charging current corresponding to the input voltage during the turn-on period of the output transistor and stops the charging during the turn-off period of the output transistor to discharge charges stored in the first offset capacitor through the first offset resistor.

As a result, it is possible to generate the first offset voltage corresponding to the ratio between the turn-on period of the output transistor and the turn-off period of the output transistor.

The switching power supply circuit of the fifth configuration may have a configuration (sixth configuration) wherein the slope voltage generation circuit includes a slope capacitor (C31) provided between a first node (ND1) and a second node (ND2), a first switch (SW1) provided between a predetermined node (ND5, ND5a) and the slope capacitor, a second switch (SW2) connected in parallel to the slope capacitor, and a switching circuit (230) that switches and outputs a voltage at the first node or the second offset voltage as the slope voltage, wherein the first offset voltage is applied to the second node, wherein during the turn-on period of the output transistor, the slope voltage generation circuit supplies a slope current corresponding to the input voltage from the predetermined node to the first node by keeping the first switch on while keeping the second switch off to thereby charge the slope capacitor and the first offset capacitor, wherein the voltage at the first node is output as the slope voltage during the turn-on period of the output transistor, wherein the supply of the slope current is cut off by turning off the first switch during the turn-off period of the output transistor, and the second switch is turned on during at least a part of the turn-off period of the output transistor to thereby discharge the charges stored in the slope capacitor, and wherein the second offset voltage is output as the slope voltage during at least a part of the turn-off period of the output transistor.

The switching power supply circuit of any one of the first to sixth configurations may have a configuration (seventh configuration) wherein the second offset voltage generation circuit has a second offset resistor (R21) and generates a second offset voltage at the second offset resistor by supplying a current corresponding to the output voltage to the second offset resistor.

A switching power supply device (1) according to another aspect of the present disclosure has a configuration (eighth configuration) that includes: the switching power supply circuit (2) of any one of the first to seventh configurations; a rectifying and smoothing circuit (3) having the output inductor (L0) and an output capacitor (C0) and configured to generate the output voltage by rectifying and smoothing a voltage appearing at a connection node between the output transistor and the synchronous rectification transistor.

According to the present disclosure in some embodiments, it is possible to provide a switching power supply circuit and a switching power supply device that contribute to an improvement in efficiency (particularly, for example, efficiency improvement at the time of a light load).

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A switching power supply circuit that includes an output stage circuit having an output transistor configured to receive an input voltage and a synchronous rectification transistor connected in series with the output transistor at a low potential side of the output transistor, and is configured to generate an output voltage from the input voltage by supplying an inductor current to an output inductor via the output transistor or the synchronous rectification transistor through turn-on/off of the output transistor and the synchronous rectification transistor, the switching power supply circuit comprising:
an error amplifier configured to generate an error voltage corresponding to a difference between a feedback voltage corresponding to the output voltage and a predetermined reference voltage;
a slope voltage generation circuit configured to generate a slope voltage;
a comparator configured to generate a comparison result signal by comparing a first comparison voltage, which is the error voltage, with a second comparison voltage which is the slope voltage or a sum of the slope voltage and a voltage corresponding to the inductor current;
a clock signal generation circuit configured to generate a clock signal having a predetermined frequency;
a control drive circuit configured to control the output stage circuit based on the clock signal and the comparison result signal; and
a reverse current detection circuit configured to detect a reverse current of the inductor current,
wherein the control drive circuit turns off the synchronous rectification transistor when the reverse current of the inductor current is detected while the synchronous rectification transistor is turned on,
wherein the slope voltage generation circuit includes:
a first offset voltage generation circuit configured to generate a first offset voltage corresponding to a ratio between a turn-on period of the output transistor and a turn-off period of the output transistor; and
a second offset voltage generation circuit configured to generate a second offset voltage according to the output voltage,
wherein the slope voltage is increased from the first offset voltage with a slope corresponding to the input voltage during the turn-on period of the output transistor, and
wherein the slope voltage is set to the second offset voltage during at least a part of the turn-off period of the output transistor.

2. The switching power supply circuit of claim 1, wherein the control drive circuit controls a state of the output stage circuit to one of an output high state in which the output transistor is turned on and the synchronous rectification transistor is turned off, an output low state in which the output transistor is turned off and the synchronous rectification transistor is turned on, and an output off state in which both the output transistor and the synchronous rectification transistor are turned off,
wherein the clock signal generation circuit changes a level of the clock signal from a first level to a second level at the predetermined frequency,
wherein the control drive circuit performs a basic unit operation when the level of the clock signal is changed from the first level to the second level when the first comparison voltage is higher than the second comparison voltage,
wherein in the basic unit operation, the control drive circuit switches the output stage circuit from the output low state or the output off state to the output high state in response to the change in the level of the clock signal from the first level to the second level, then switches the output stage circuit from the output high state to the output low state in response to an input of the comparison result signal indicating that the second comparison voltage has reached the first comparison voltage, and thereafter switches the output stage circuit from the output low state to the output off state when the reverse current of the inductor current is detected, and
wherein the control drive circuit sets the state of the output stage circuit to the output off state through the detection of the reverse current of the inductor current and then performs a skip control in which the output stage circuit is maintained in the output off state irrespective of the clock signal during a period in which the first comparison voltage is lower than the second comparison voltage.

3. The switching power supply circuit of claim 1, wherein the first offset voltage generation circuit decreases the first offset voltage as the ratio of the turn-on period of the output transistor to the turn-off period of the output transistor decreases.

4. The switching power supply circuit of claim 1, wherein the error amplifier decreases the error voltage when the feedback voltage is higher than the predetermined reference voltage, and increases the error voltage when the feedback voltage is lower than the predetermined reference voltage.

5. The switching power supply circuit of claim 1, wherein the first offset voltage generation circuit includes a first offset capacitor and a first offset resistor connected in parallel to the first offset capacitor,
wherein the first offset voltage is generated across the first offset capacitor, and
wherein the slope voltage generation circuit charges the first offset capacitor with a charging current corresponding to the input voltage during the turn-on period of the output transistor and stops the charging during the turn-off period of the output transistor to discharge charges stored in the first offset capacitor through the first offset resistor.

6. The switching power supply circuit of claim 5, wherein the slope voltage generation circuit includes a slope capacitor provided between a first node and a second node, a first switch provided between a predetermined node and the slope capacitor, a second switch connected in parallel to the slope capacitor, and a switching circuit that switches and outputs a voltage at the first node or the second offset voltage as the slope voltage,
wherein the first offset voltage is applied to the second node,
wherein during the turn-on period of the output transistor, the slope voltage generation circuit supplies a slope current corresponding to the input voltage from the predetermined node to the first node by keeping the first switch on while keeping the second switch off so as to charge the slope capacitor and the first offset capacitor,
wherein the voltage at the first node is output as the slope voltage during the turn-on period of the output transistor,
wherein the supply of the slope current is cut off by turning off the first switch during the turn-off period of the output transistor, and the second switch is turned on during at least a part of the turn-off period of the output transistor so as to discharge the charges stored in the slope capacitor, and
wherein the second offset voltage is output as the slope voltage during at least a part of the turn-off period of the output transistor.

7. The switching power supply circuit of claim 1, wherein the second offset voltage generation circuit includes a second offset resistor and generates the second offset voltage at the second offset resistor by supplying a current corresponding to the output voltage to the second offset resistor.

8. A switching power supply device comprising:
the switching power supply circuit of claim 1; and
a rectifying and smoothing circuit having the output inductor and an output capacitor and configured to generate the output voltage by rectifying and smoothing a voltage appearing at a connection node between the output transistor and the synchronous rectification transistor.
